(19) United States
(12) Patent Application Publication
(10) Pub. No.: US 2024/0322157 A1
(43) Pub. Date: Sep. 26, 2024

(54) BIPOLAR LITHIUM ION CATHODES AND CELLS AND BATTERIES CONTAINING LITHIUM ION CATHODES

(71) Applicant: ADVANCED CELL ENGINEERING, INC., Stuart, FL (US)

(72) Inventors: John Kaufman, Palm City, FL (US); Karim Zaghib, Longueil (CA); Ayyakkannu Manivannan, Stuart, FL (US); Thomas Madden, Stuart, FL (US)

(21) Appl. No.: 18/559,767

(22) PCT Filed: Nov. 8, 2022
(86) PCT No.: PCT/US2022/049304

§ 371 Date: Nov. 8, 2023

Related U.S. Application Data
(60) Provisional application No. 63/277,083, filed on Nov. 8, 2021.
(60) Provisional application No. 63/277,084, filed on Nov. 8, 2021.
(60) Provisional application No. 63/310,979, filed on Feb. 16, 2022.
(60) Provisional application No. 63/340,353, filed on May 10, 2022.
(60) Provisional application No. 63/400,355, filed on Aug. 23, 2022.
(60) Provisional application No. 63/410,538, filed on Sep. 27, 2022.

(51) Int. Cl. H01M 4/525; H01M 4/02; H01M 4/36; H01M 4/505; H01M 4/58; H01M 4/583; H01M 10/0525; H01M 50/434

(52) U.S. Cl. CPC H01M 4/525; H01M 4/364; H01M 4/505; H01M 4/5825; H01M 4/583; H01M 10/0525; H01M 50/434; H01M 2004/027; H01M 2004/028; H01M 2004/029

(57) ABSTRACT

The present disclosure provides a bipolar lithium ion cathode including two different cathode active materials located in two different cathode layers, a bipolar lithium ion cell including such a cathode, a battery including such a cell, a battery module or pack including such a battery and a method of forming a bipolar lithium ion cathode.

### PRIORITY CLAIM

The present application claims priority to U.S. Provisional Patent Application No. 63/277,083, filed Nov. 8, 2021, titled “BIPOLAR LITHIUM ION CATHODES AND CELLS AND BATTERIES CONTAINING LITHIUM ION CATHODES”, U.S. Provisional Patent Application No. 63/400,355, filed Aug. 23, 2022, titled “BIPOLAR LITHIUM ION CATHODES AND CELLS AND BATTERIES CONTAINING LITHIUM ION CATHODES”, U.S. Provisional Patent Application No. 63/277,084, filed Nov. 8, 2021, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/410,538, filed Sep. 27, 2022, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/310,979, filed Feb. 16, 2022, titled “HIGH CAPACITY LITHIUM ION ANODES AND CELLS AND BATTERIES CONTAINING LITHIUM ION ANODES”, and U.S. Provisional Patent Application No. 63/340,353, filed May 10, 2022, titled “SLOT ELECTRODE STACK AND ELECTROCHEMICAL CELLS AND BATTERIES CONTAINING A SLOT ELECTRODE STACK”, each of which is incorporated by reference herein in its entirety.

### TECHNICAL FIELD

The present disclosure relates to bipolar lithium ion cathodes, cells, and batteries with bipolar lithium ion high voltage cathodes as well as methods of forming these cathodes, cells, or batteries. These cathodes as well as cells and batteries containing them may exhibit high charge-discharge energy densities.

### BACKGROUND

Lithium batteries are widely used in consumer electronics due to their relatively high energy density. Rechargeable batteries are also referred to as secondary batteries, and lithium ion batteries are typically secondary batteries. Lithium ion secondary batteries generally have a negative electrode (anode) material that intercalates lithium. For many current commercial batteries, the negative electrode material is graphite, and the positive electrode (cathode) material is lithium cobalt oxide (LiCoO₂). In practice, only roughly 50% of the theoretical capacity of the cathode can be used in these batteries, e.g., roughly 140 milliamp hours per gram (mAh/g). This inability to effectively use a great deal of the available capacity of lithium cobalt oxide batteries means that a heavier battery is required to store energy. In a practical example, this would translate to a lithium cobalt oxide laptop battery that weighs two pounds to power the laptop for four hours, when, theoretically, the battery should only need to weight about one pound, so the laptop could be a pound lighter or last eight hours instead of four on a single charge.

Other lithium ion batteries use LiMn₂O₄, having a spinel structure, and LiFePO₄, having an olivine structure as cathode materials. These materials have not provided any significant improvements in energy density as compared to lithium cobalt oxide.

Lithium ion batteries are generally classified into two categories based on their application. The first category is high power batteries which contain individual cells that are designed to deliver high current for applications such as power tools and hybrid electric vehicles (HEVs). However, by design, these battery cells are lower in energy since a design providing for high current generally reduces total energy that can be delivered from the cell. The second category is high energy batteries, which contain cells that are designed to deliver low to moderate current for applications such as cellular phones, lap-top computers, electric vehicles (EVs) and plug-in hybrid electric vehicles (PHEVs) with the delivery of higher total energy.

### SUMMARY

The present disclosure provides a bipolar lithium ion cathode comprising two different cathode active materials located in two distinct cathode layers on a single current collector.

In some embodiments, which may be combined with one another and with any other features of a bipolar cathode disclosed herein:
the two different cathode layers are disposed adjacent to one another, and the current collector is disposed adjacent to one cathode layer only;
the current collector is disposed adjacent to and between the two different cathode layers;
the two different cathode layers are both disposed adjacent to the current collector in different regions on a surface of the current collector;
the cathode comprises two layers each of the distinct cathode layers in which, on one side of the current collector, the two different cathode layers are disposed adjacent to one another and the current collector is disposed adjacent to a first type of cathode layer only and, on an opposite side of the current collector, two different cathode layers are disposed adjacent to cone another and the current collector is disposed adjacent to the first type of cathode layer only;
the two different cathode active materials are selected from: lithium nickel manganese cobalt oxide (NMC) in which nickel (Ni) is present in at least 50 wt % of the total weight of Ni, manganese (Mn), and cobalt (Co); lithium nickel cobalt aluminum oxide (NCA); lithium nickel manganese cobalt aluminum oxide (NMCA), lithium iron phosphate (LFP), lithium manganese iron phosphate (LMFP), lithium manganese nickel iron phosphate (LMNFP), lithium iron cobalt phosphate (LFCP), lithium iron manganese cobalt phosphate (LFMCP), and any combinations thereof;
the NMC has the general chemical formula LiNi_{1-x-y} MnₓCo_{y}O₂, wherein 1−x−y, x, and y are each greater than 0, and 1−x−y is such that Ni is present in an amount of at least 50 wt % of the total weight of Ni, Mn, and Co; or wherein x is such that Mn is present in an amount of up to 30 wt % of the total weight of the NMC;
the NCA has the general chemical formula LiNi_{1-x-y} CoₓAl_{y}O₂, wherein 0<x≤0.2 and 0<y≤0.2, or wherein 1−x−y is such that Ni is present in an amount of at least 50 wt % of the total weight of Ni, Co, and aluminum (Al);
the NMCA has the general chemical formula LiNi_{1-x-y-z}MnₓCo_{y}Al_{z}O₂, wherein 0<x≤0.2, 0<y≤0.2, and 0<z≤0.2, or wherein 1−x−y−z is such that Ni is present in an amount of at least 50 wt % of the total weight of Ni, Mn, Co, and Al;
the LFP has the general chemical formula LiFePO₄;
the LMFP has the general chemical formula LiFe₁₋ₓ MnₓPO₄, wherein 0<x<1;
the LMNFP has the general chemical formula LiFe_{1-(x+y)}MnₓNi_{y}PO₄, wherein 0<x<1, 0<y<1 and x+y<1;
the LFCP has the general chemical formula LiFe₁₋ₓ CoₓPO₄, in which 0<x<1;
the LFMCP has the general chemical formula LiFe_{1-(x+y)}MnₓCo_{y}PO₄, in which 0<x<1, 0<y<1 and x+y<1.
the NMC, NCA, NMCA, LFP, LMFP, LMNFP, LFCP, or LFMCP is partially unlithiated;
the two different cathode active materials comprise two NMCs with different wt % Ni, NMC and NCA, NMC and NMCA, NMC and LFP, or NMC and LMFP; or
at least one cathode layer further comprises a conductivity enhancer, a polymer binder, or both.

The present disclosure further provides a bipolar lithium ion cell comprising: a bipolar cathode as described above or otherwise herein; an anode comprising an anode active material; and an electrolyte.

In some embodiments, which may be combined with one another and with any other features of a cell disclosed herein:
the anode active material comprises a material selected from: a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof;
the anode active material comprises graphite and silicon;
the anode comprises a lithium reservoir;
the electrolyte does not contain lithium hexafluorophosphate as an electrolyte lithium salt;
the electrolyte comprises an ionic liquid, an organic liquid, or a combination thereof and a lithium salt;
the electrolyte further comprises a flame retardant;
the cell further comprises a separator between the cathode and the anode, wherein the separator is coated on one or both sides with a ceramic material;
the cell has a discharge energy density of 200 Wh/kg or more when discharged from 4.5V to 2.5V at C/3;
the cell has a volumetric discharge energy density of 600 Wh/L or more when discharged from 4.5V to 2.5V at C/3;
the cell has a cycle life of about 500 cycles or more;
the bipolar cathode has a specific capacity that is about 100 mAh/g or more when measured at 23° C. when charged from 4.5 V; or
the bipolar cathode has a tap density of about 2 g/cm³ or more or more when measured at 23° C. when charged from 4.5 V.

The present disclosure further provides a battery comprising: at least one lithium ion cell as described above or otherwise herein; and a casing.

In some embodiments, which may be combined with one another and with any other features of a battery disclosed herein:
the battery is a cylindrical cell, a pouch cell, or a prismatic cell;
the casing comprises a vent; or
the battery comprises an electrode stack having a slotted structure created by an accordion-shaped separator.

The present disclosure further provides a battery module or pack, such as a vehicle battery, comprising: at least one battery as described above or otherwise herein; a positive connector; a negative connector; and a housing.

In some embodiments, which may be combined any other features of a battery module or pack disclosed herein, the battery module or pack further comprises safety equipment, control equipment, or any combinations thereof.

The present disclosure further provides a method of forming a bipolar cathode as described above or otherwise herein, the method comprising: forming a first cathode layer comprising a first cathode active material on a current collector; and forming a second cathode layer comprising a second cathode active material on the first cathode layer or on the current collector. In some embodiments, which may be combined with any other features of a method disclosed herein, the method comprises forming a bipolar cathode having a configuration of cathode layers and current collector as described above.

### BRIEF DESCRIPTION OF THE DRAWINGS

The disclosure may be better understood through reference to the following figures, which are not to scale, which depict embodiments of the present disclosure, and in which:

FIG. 1 is a schematic cross-sectional diagram of a cell having a bipolar lithium ion cathode in which the planar orientation of the cathode is indicated by x and z;

FIG. 2 is a schematic cross-sectional diagram of a bipolar lithium ion cathode having a different configuration in which the planar orientation of the cathode as compared to the cathode of FIG. 1 is indicated by x and z;

FIG. 3 is a schematic top-view diagram of a bipolar lithium ion cathode having another different configuration in which the planar orientation of the cathode as compared to the cathode of FIG. 1 is indicated by x and y;

FIG. 4 is a schematic top-view diagram of a bipolar lithium ion cathode having yet another different configuration in which the planar orientation of the cathode as compared to the cathode of FIG. 1 is indicated by x and y;

FIG. 5 is a schematic, cut-away elevation view diagram of a cylindrical battery having a jelly-roll configuration and including a bipolar lithium ion cathode from FIG. 1;

FIG. 6 is a schematic, partially cross-sectional elevation view diagram of a prismatic cell battery including a bipolar lithium ion cathode from FIG. 1; and

FIG. 7 is a schematic diagram of an electric vehicle battery including a battery module or pack, including prismatic cell batteries of FIG. 6.

### DETAILED DESCRIPTION

The present disclosure relates to bipolar lithium ion cathodes, cells, and batteries. These cathodes, when assembled into cells and batteries, and the cells and batteries containing them may exhibit high energy density as well as high total energy as compared to compared to otherwise similar cells and batteries with lithium cobalt oxide cathodes. The cells and batteries may also exhibit sufficient cycle life to be commercially useful, for example in small electronic devices, such as phones, portable gaming systems, smartwatches, and laptop computers, as well as in EVs and PEVs, or grid storage. The present disclosure also provides methods of manufacturing bipolar high voltage cathodes and cells and batteries containing them.

As used herein following terms are ascribed the following meanings:

Chemical abbreviations are employed as is typical in the art. For example, a lithium ion may be designated as Li⁺ and an electron may be designated as e⁻. Weight % may be abbreviated as “wt %.” The notation C/x indicates that a cell or battery is discharged at a rate to fully discharge the cell or battery to the selected lower voltage cut off in x hours.

A “cathode” (which may also be referred to as a “positive electrode”) is the electrode to which, during discharge of a lithium ion electrochemical cell, electrons flow and combine with lithium ion (typically in the context of a metal oxide insertion or de-insertion g the lithium ion). During charge of the electrochemical cell, electrons flow from the cathode and lithium ions are also released from the cathode.

A “cathode active material” is a chemical that undergoes electrochemical reaction in the cathode to exchange lithium ions and electrons with other components of the electrochemical cell.

A “bipolar cathode” is a cathode including two different layers that differ in their cathode active material compositions and, thus, also in their energy density and power density. In the simplest version of a bipolar cathode, a first layer contains a first cathode active material and the second layer contains a second cathode active material, which differs in chemical composition and at least one electrochemical property from the first cathode active material. “Bipolar cathode” does not denote a conventional bipolar battery stack configuration.

An “anode” (which may also be referred to as a “negative electrode”) is the electrode from which, during discharge of a lithium ion electrochemical cell, electrons flow and from which lithium ions are released. During charge of the electrochemical cell, electrons flow to the anode, where they combine with lithium ion, often to form lithium metal (Li).

An “anode active material” is a chemical that undergoes electrochemical reaction in the anode to exchange lithium ions and electrons with other components of the electrochemical cell, or upon which lithium metal may be plated or removed as lithium ions and electrons are separated and recombined by the electrochemical reaction.

A “current collector” is a component of the cathode or anode that exchanges electrons directly or indirectly with the active material to allow the electrochemical reaction to proceed.

An “electrolyte” is a substance that can exchange lithium ions with the cathode and anode. Although many examples in the present specification relate to liquid electrolytes, suitable non-liquid electrolytes, such as gel or solid electrolytes, may also be used in electrochemical cells encompassed by the present disclosure.

A “cell” or “electrochemical cell” is a basic physical unit in which a complete electrochemical reaction may occur if the cell is electrically connected to an external energy sink or energy source. An electrochemical cell includes a cathode, and anode, and an electrolyte. Unless the electrolyte forms an electrically non-conductive barrier between the anode and cathode, the electrochemical cell also contains a separator that forms an electrically non-conductive barrier between the anode and cathode. An electrochemical cell also includes a container that maintains the electrochemical cell as a physical unit, such as by containing a liquid electrolyte, excluding air or water from the cell, or protecting the cell components from physical damage.

A “battery” is a more complex physical unit that includes at least one electrochemical cell combined with at least one other component not a part of the electrochemical cell, such as a housing or a second or more electrochemical cells. A battery may also include other components, such as vents, air circulation systems, fire suppression systems, electrical conductors, such as wiring or bars, identification components, and even a processor and associated memory, which may for example, assess battery status and control battery functions. Such an integrated assembly may also be referred to as a pack or module.

“Uncycled” refers to a cell or battery that has never been charged and discharged or to an anode or cathode or an anode active material or cathode active material that has never been charged and discharged in a cell or battery.

“Hard carbon” is a solid form of carbon that cannot be converted to graphite by heat-treatment at temperatures up to 3000° C. and may also be referred to as “non-graphitizing carbon” as a result. Hard carbon may be formed by heating a suitable carbon-based precursor to 1000° C. in the absence of oxygen.

Unless otherwise specified, the term “including” is used in the expansive sense and means “not limited to.” Likewise, “or” is used expansively and means both one of the listed options and combination of more than one of the listed options (i.e. and/or). “A” “an,” and “the” include more than one. “About,” as used herein, means within a variation of 1%.

Numerical designations followed by a and b indicate similar components that may collectively be referred to by the numeral only. Specifically, a reference to “cathode active material 50” should be interpreted as referring to either cathode active material 50a, cathode active material 50b, or both. A reference to “cathode layer 30” should be interpreted as referring to either cathode layer 30a, cathode layer 30b, or both.

All lists items disclosed herein should be interpreted as including any combinations thereof unless otherwise specified.

All bounded and unbounded ranges recited herein should be interpreted as including both all values between the endpoint values (or above or below the endpoint value, as the case may be, for unbounded ranges) and the endpoint values. The terms “in a range from” and “between” both include endpoint values.

### Bipolar Cathode Cells

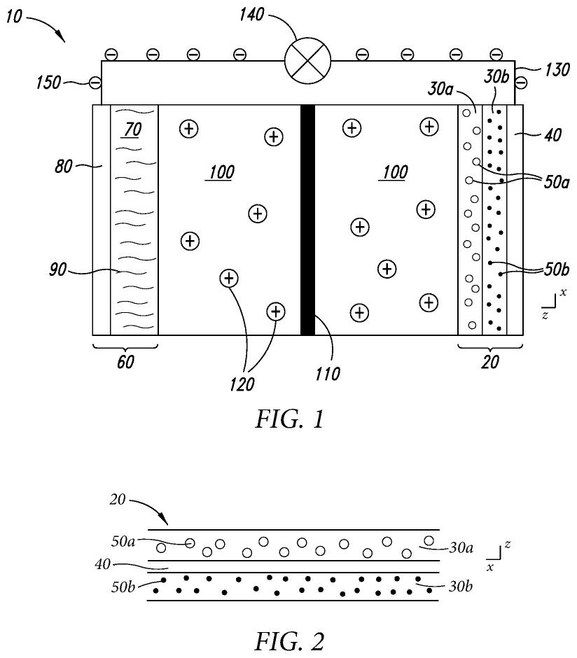

Referring now to FIGS. 1-7, the present disclosure, according to some embodiments, provides an electrochemical cell 10, which may be in a battery, for example battery 200, battery 300, or battery 400. The electrochemical cell 10 includes a bipolar cathode 20, and anode 60, and an electrolyte 100.

Bipolar cathode 20 includes at least two cathode layers 30a and 30b that contain at least two cathode active materials 50a and 50b, respectively. Bipolar cathode 20 further includes cathode current collector 40.

Anode 60 includes anode layer 70 that contains anode active material 90. Anode 60 also includes anode current collector 80.

Electrolyte 100 contains lithium ions 120. Separator 110 electrically insulates bipolar cathode 20 from anode 60 within electrochemical cell 10. Separator 110 allows at least lithium ions 120 to pass through it.

Electrochemical cell 10, when connected to electrically conductive external circuit 130, allows electrons 150 to pass through external circuit 130 from the anode to the cathode or vice versa.

In the example depicted in FIG. 1, electrochemical cell 10 is being discharged to power external load 140. If electrochemical cell 10 were being charged, an energy source, such as an DC power supply, would be in place of external load 140.

The bipolar cathode 20 may contain the cathode layers 30a and 30b and current collector 40 in any of a number of configurations with respect to one another. In the embodiment shown in FIG. 1, the cathode layers 30a and 30b are disposed adjacent to one another, with the current collector 40 being disposed adjacent to cathode layer 30b.

In another embodiment, illustrated in FIG. 2, the cathode layers 30a and 30b are both disposed adjacent to the current collector 40, such that the current collector 40 is sandwiched between the cathode layers. In some embodiments, not depicted, cathode layers may be formed on both sides of the cathode current collector, with the same type of layer adjacent the current collector on both sides, as if the layers of FIG. 1 were placed on either side of the current collector as shown in FIG. 2.

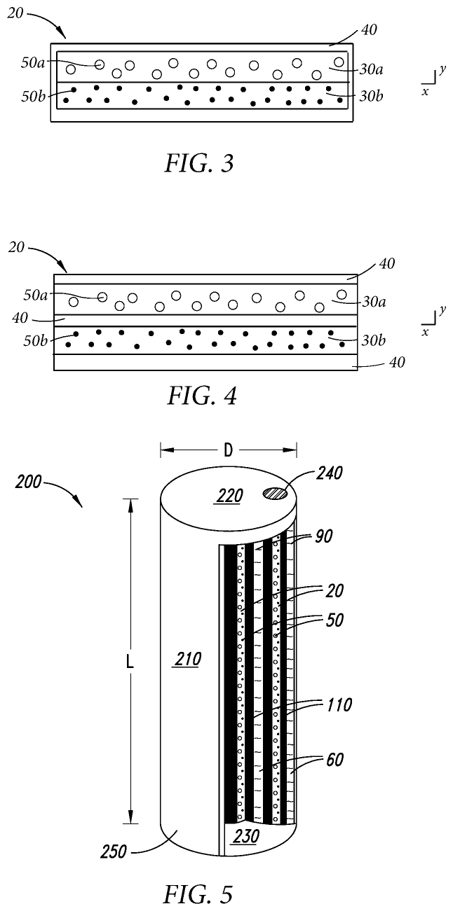

In another embodiment, illustrated in FIG. 3, the cathode layers 30a and 30b are in a single layer adjacent to the current collector 40, but on different regions of surface the current collector 40, where the surface of current collector 40 is defined by the two dimensions that result in the greatest area.

In yet another embodiment, illustrated in FIG. 4, the cathode layers 30a and 30b are disposed generally as shown FIG. 3 but with a gap between the cathode layers 30a and 30b, such that a portion of the surface of the current collector 40 is not covered by cathode active material.

### Bipolar Cathodes

The cathode active materials 50a and 50b may be two different lithium metal oxides (LMOs), two different lithium metal phosphates (LMPs), or a lithium metal oxide and a lithium metal phosphate. The cathode active material may generally be present in a crystalline, and not amorphous, form. In particular, the lithium metal oxides may be those that exhibit a layered crystal structure, similar to that of lithium cobalt oxide, more particularly a rhombohedral lattice, hexagonal class crystal structure, such as that of space group R-3m. The lithium metal phosphates may be those that exhibit an orthorhombic crystal structure of space group Pnma, sometimes referred to as an olivine structure. Some cathode active materials may have spinel structure.

In specific embodiments, a bipolar cathode 20 includes cathode active material 50 that are at least two of lithium nickel manganese cobalt oxide (LiNi/Mn/CoO₂, also referred to as “NMC”) in which Ni is present in at least 50 wt % of the total weight of Ni, Mn, and Co, lithium nickel cobalt aluminum oxide (LiNi/Co/AlO₂, also referred to as “NCA”), lithium nickel manganese cobalt aluminum oxide (LiNi/Mn/Co/AlO₂, also referred to as NMCA), lithium iron phosphate (also referred to as “LFP”), lithium manganese iron phosphate (also referred to as “LMFP”), lithium manganese nickel iron phosphate (also referred to as “LMNFP”), lithium iron cobalt phosphate (“LFCP”), or lithium iron manganese cobalt phosphate (“LFMCP”), in any combinations. In other specific embodiments, the bipolar cathode 20 includes a combination of two or more NMCs that differ in their respective relative amounts of Ni, Mn, and Co.

In some embodiments, the cathode, when in an uncycled state, also contains an unlithiated metal oxide, such as an unlithiated metal phosphate in addition to the lithiated materials. In some embodiments, the unlithiated metal oxide has the same chemical composition as the lithiated metal oxide, but without lithium (e.g. LiFePO₄ and FePO₄). In other embodiments, the unlithiated metal oxide has a different chemical composition than the lithiated metal oxide (e.g. LiFePO₄ and MnFePO₄ or LiMn_{0.2}Fe_{0.8}PO₄ and Mn_{0.15}Fe_{0.85}PO₄).

In more specific embodiments, Li may be present in an amount between 1 wt % and 20 wt %, about 5 wt % and 20 wt %, about 10 wt % and 50 wt %, or about 15 wt % and 20 wt %. In such embodiments, the anode may not contain lithium ion or lithium metal. In some embodiments, Li may be present in these amounts in the cathode or in the entire cell and the anode may include a lithium reservoir.

In other embodiments the cathode may contain at least two distinct cathode active materials or mixtures of cathode active materials in the form of a bipolar cathode.

In specific embodiments, NMC contains Ni in an amount that is at least 50 wt % of the total weight of Ni, Mn, and Co.

Cathode active materials that contain manganese may suffer decreases in performance or failure due to dissolution of manganese through the cell, particularly during use. Non-lithiated metal phosphate in cathode active materials and cathode of the present disclosure may act as a stabilizing and balancing factor that decreases or prevents manganese dissolution during use of a cell.

In some embodiments, one or more, or all of the cathode active materials may not contain cobalt. In contrast to toxic cobalt, iron, manganese, and nickel are generally non-toxic and, even if released by damage to a battery, are very unlikely to be taken up by the body in harmful amounts. In addition, these cathode active materials may help prevent thermal runaway and resulting battery or cell damage and fires. However, embodiments in which one or more, or all of the cathode active materials do contain cobalt are also suitable for use in a bipolar cathode as disclosed herein.

In some embodiments, the NMC has the general chemical formula LiNi_{1-x-y}MnₓCo_{y}O₂, wherein 1−x−y, x, and y are each greater than 0, and 1−x−y is such that Ni is present in an amount of at least 50 wt % of the total weight of Ni, Mn, and Co, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y is such that Ni is present in an amount of at least 80 wt % of the total weight of Ni, Mn, and Co, such as between 80 wt % and about 99 wt %, between 80 wt % and about 95 wt %, between 80 wt % and about 90 wt %, or between 80 wt % and about 85 wt %.

In some embodiments in which the NMC has the general chemical formula LiNi_{1-x-y}MnₓCo_{y}O₂, wherein x is such that Mn is present in an amount of up to 30 wt % of the total weight of the NMC. In more specific embodiments, Mn may be present in an amount of between about 1 wt % and 30 wt %, about 5 wt % % and 30 wt %, about 10 wt % and 30 wt % %, or about 20 wt % and 30 wt %.

In a more specific embodiment, the NMC has the chemical formula LiNi_{0.8}Co_{0.1}Mn_{0.1}O₂.

In some embodiments, the NCA has the general chemical formula LiNi_{1-x-y} CoₓAl_{y}O₂, wherein 1−x−y, x, and y are each greater than 0. In specific embodiments, 0<x≤0.2, more specifically 0.01≤x≤0.2, 0.1<x≤0.2 and 0<y≤0.2 more specifically 0.01≤y≤0.2, 0.1≤y≤0.2. In more specific embodiments, 0.6≤(1−x−y)≤0.99, more specifically, 0.6≤(1−x−y)≤0.9, 0.6≤(1−x−y)≤0.8, 0.6≤(1−x−y)≤0.7.

In some embodiments, the NCA has the general chemical formula LiNi_{1-x-y} CoₓAl_{y}O₂, and 1−x−y is such that Ni is present in an amount of at least 50 wt % of the total weight of Ni, Co, and Al, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y is such that Ni is present in an amount of at least 80 wt % of the total weight of Ni, Co, and Al, such as between 80 wt % and about 99 wt %, between 80 wt % and about 95 wt %, between 80 wt % and about 90 wt %, or between 80 wt % and about 85 wt %.

In some embodiments, the NMCA has the general chemical formula LiNi_{1-x-y-z}MnₓCo_{y}Al_{z}O₂, wherein 1−x−y−z, x, y, and z are each greater than 0. In specific embodiments, 0<x≤0.2, more specifically 0.01≤x≤0.2, 0.1≤x≤0.2, 0<y≤0.2 more specifically 0.01≤y≤0.2, 0.1≤y≤0.2, and 0≤z≤0.2, more specifically 0.01≤z≤0.2, 0.1≤z≤0.2. In more specific embodiments, 0.4≤(1−x−y−z)≤0.99, more specifically, 0.4≤(1−x−y)≤0.9, 0.4≤(1−x−y)≤0.8, 0.4≤(1−x−y)≤0.7.

In some embodiments, the NMCA has the general chemical formula LiNi_{1-x-y-z}MnₓCo_{y}Al_{z}O₂, wherein 1−x−y−z is such that Ni is present in an amount of at least 50 wt % of the total weight of Ni, Mn, Co, and Al, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y−z is such that Ni is present in an amount of at least 80 wt % of the total weight of Ni, Mn, Co, and Al, such as between 80 wt % and about 99 wt %, between 80 wt % and about 95 wt %, between 80 wt % and about 90 wt %, or between 80 wt % and about 85 wt %.

In some embodiments, the LFP has the general chemical formula LiFePO₄.

Lithium metal phosphate cathode active materials 50a may include LMFP. In some embodiments, these materials have the general chemical formula LiMnₓFe₁₋ₓ PO₄, wherein 0.01≤x≤0.95.

In more specific embodiments, 0.01≤x≤0.5, 0.01≤x≤0.4, 0.01≤x≤0.3, 0.01≤x≤0.25, 0.01≤x≤0.2, 0.01≤x≤0.15, 0.01≤x≤0.10, 0.01≤x≤0.05, 0.05≤x≤0.95, 0.05≤x≤0.5, 0.05≤x≤0.4, 0.05≤x≤0.3, 0.05≤x≤0.25, 0.05≤x≤0.2, 0.05≤x≤0.15, 0.05≤x≤0.1, 0.1≤x≤0.95, 0.1≤x≤0.5, 0.1≤x≤0.4, 0.1≤x≤0.3, 0.1≤x≤0.25, 0.1≤x≤0.2, 0.1≤x≤0.15, 0.15≤x≤0.95, 0.15≤x≤0.5, 0.15≤x≤0.4, 0.15<x≤0.3, 0.15≤x≤0.25, 0.15≤x≤0.2, 0.2≤x≤0.95, 0.2≤x≤0.5, 0.2≤x≤0.4, 0.2≤x≤0.3, or 0.2≤x≤0.25. In a more specific embodiment, the materials have the chemical formula LiMn_{0.2}Fe_{0.8}PO₄.

In other more specific embodiments, 0.5≤x≤0.95, 0.5≤x≤0.8, 0.5≤x≤0.7, 0.5≤x≤0.6, 0.6≤x≤0.95, 0.65≤x≤0.8, 0.6≤x≤0.7, 0.7≤x≤0.95, 0.7≤x≤0.8, or 0.8≤x≤0.95. In a more specific embodiment, the materials have the chemical formula LiMn_{0.5}Fe_{0.5}PO₄, and LiMn_{0.8}Fe_{0.2} PO₄.

Lithium metal phosphate cathode active materials 50a may include LMNFP. In some embodiments, these materials have the general chemical formula LiMnₓNi_{y}Fe_{1-(x+y)}PO₄, in which 0<x<1, 0<y<1 and x+y<1. In some specific embodiments:

a) 0<x≤0.05, more particularly 0.005≤x≤0.05, 0.005≤x≤0.04, 0.005≤x≤0.03, 0.005≤x≤0.02, 0.01≤x≤0.05, 0.01≤x≤0.04, 0.01≤x≤0.03, 0.01≤x≤0.02, 0.02≤x≤0.05, 0.02≤x≤0.04, 0.02≤x≤0.03, 0.03≤x≤0.05, 03, 0.03≤x≤0.04, or 0.04≤x≤0.05;

b) 0<y≤0.3, more particularly 0.005≤y≤0.3, 0.005≤y≤0.25, 0.005≤y≤0.2, 0.005≤y≤0.16, 0.005≤y≤0.15, 0.005≤y≤0.1, 0.005≤y≤0.05, 0.005≤y≤0.01, 0.01≤y≤0.3, 0.01≤y≤0.25, 0.01≤y≤0.2, 0.01≤y≤0.16, 0.01≤y≤0.15, 0.01≤y≤0.1, 0.01≤y≤0.05, 0.05≤y≤0.3, 0.05≤y≤0.25, 0.05≤y≤0.2, 0.05≤y≤0.16, 0.05≤y≤0.15, 0.05≤y≤0.1, 0.1≤y≤0.3, 0.1≤y≤0.25, 0.1≤y≤0.2, 0.1≤y≤0.16, 0.1≤y≤0.15, 0.15≤y≤0.3, 0.15≤y≤0.25, 0.15≤y≤0.2, 0.15≤y≤0.16, 0.16≤y≤0.3, 0.16≤y≤0.25, 0.16≤y≤0.2, 0.2≤y≤0.3, 0.2≤y≤0.25, or 0.25≤y≤0.3; or
c) 0<x+y≤0.3, more particularly 0.005≤x+y≤0.3, 0.005≤x+y≤0.25, 0.005≤x+y≤0.2, 0.005≤x+y≤0.15, 0.005≤x+y≤0.1, 0.005≤x+y≤0.05, 0.005≤x+y≤0.01, 0.01≥x+y≤0.3, 0.01≤x+y≤0.25, 0.01≤x+y≤0.2, 0.01≤x+y≤0.15, 0.01≤x+y≤0.1, 0.01≤x+y≤0.05, 0.05≤x+y≤0.3, 0.05≤x+y≤0.25, 0.05≤x+y≤0.2, 0.05≤x+y≤0.15, 0.05≤x+y≤50.1, 0.1≤x+y≤0.3, 0.1≤x+y≤0.25, 0.1≤x+y≤0.2, 0.1≤x+y≤0.15, 0.15≤x+y≤0.3, 0.15≤x+y≤0.25, 0.15≤x+y≤0.2, 0.2≤x+y≤0.3, 0.2≤x+y≤0.25, or 0.25≤x+y≤0.3.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

In a more specific embodiment, the materials have the chemical formula LiMn_{0.04}Ni_{0.16}Fe_{0.8}PO₄.

In some embodiments, LFCP has the general chemical formula LiFe₁₋ₓ CoₓPO₄, in which x<1. In some specific embodiments, x≥0.05, x≥0.1, x≥0.2, x≥0.3, x≥0.4, x≥0.5, x≥0.6, x≥0.7, x≥0.8, x≥0.9, or x≥0.95.

In some embodiments, LFMCP has the general chemical formula LiFe_{1-(x+y)}MnₓCo_{y}PO₄, in which 0<x<1, 0<y<1 and x+y<1. In some specific embodiments, a) 0<x≤0.5, more particularly 0.05≤x≤0.50, 0.05≤x≤0.25, 0.05≤x≤0.2, 0.05≤x≤0.15, 0.05≤x≤0.1, 0.1≤x≤0.5, 0.1≤x≤0.25, 0.1≤x≤0.2, or 0.1≤x≤0.15; b) 0≤y≤0.95, more particularly 0.05≤y≤0.95, 0.05≤y≤0.9, 0.05≤y≤0.75, 0.05≤y≤0.5, 0.05≤y≤0.25, 0.05≤y≤0.1, 0.1≤y≤0.95, 0.1≤y≤0.9, 0.1≤y≤0.75, 0.1≤y≤0.5, or 0.1≤y≤0.25; or c) 0≤x+y≤0.95, more particularly 0.05≤x+y≤0.95, 0.05≤x+y≤0.75, 0.05≤x+y≤0.5, 0.05≤x+y≤0.25, 0.05≤x+y≤0.1, 0.1≤x+y≤0.95, 0.1≤x+y≤0.9, 0.1≤x+y≤0.75, 0.15≤x+y≤0.5, or 0.1≤x+y≤0.25.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

In some embodiments, NMC, NCA, NMCA, LFP, LMFP, LMNFP, LFCP, or LFMCP may include additional elements included in their crystal structures. These additional elements may affect electrical conductivity and/or lithium ion intercalation of the cathode active material. Additional elements may have or be capable of existing in a charge state equal to that of the element replaced in the crystal structure. For example, iron may be replaced with another element that may exist in a 2+ or 3+ charge state. The additional element may be a transition metal also able to move from one charge to another during an electrochemical reaction, or if may be a fixed valence material, such as a fixed-valence 2+ metal in place of iron. Phosphorus may also be replaced, where present with sulfur or silicon. The amount of transition metal replaced by another metal may be 10%, 5%, 2%, 1%, 0.5%, or 0.1% or less, or in a range of 0.1% 15 to 10%, 0.1% to 5%, 0.1% to 2%, 0.1% to 1%, 0.1% to 0.5%, 0.5% to 5%, 0.5% to 2%, 0.5% to 1%, 1% to 5%, 1% to 2%, or 2% to 5%.

In some embodiments, the NMC, NCA, NMCA, LFP, LMFP, LMNFP, LFCP, or LFMCP may be partially unlithiated when the cell 10 is uncycled. In specific embodiments, NMC, NCA, NMCA, LFP, LMFP, LMNFP, LFCP, or LFMCP may and contain lithium in an amount up to 20 wt % of the total weight of the NMC, NCA, NMCA, LFP, LMFP, LMNFP, LFCP, or LFMCP. In more specific embodiments, Li may be present in an amount between 1 wt % and 20 wt %, about 5 wt % and 20 wt %, about 10 wt % and 50 wt %, or about 15 wt % and 20 wt %. In such embodiments, the anode may not contain lithium ion or lithium metal. In some embodiments, Li may be present in these amounts in the cathode or in the entire cell and the anode may include a lithium reservoir. This results in a cell in which all of the NMC, NCA, NMCA, LFP, LMFP, LMNFP, LFCP, or LFMCP is normally not fully lithiated, even when the cell is fully discharged.

More specifically, during normal operation, the electrochemical cell 10 largely cycles at most only the number of lithium ions present in the cathode active material 50 that is present when the cathode layers 30 are formed, prior to the initial cycling. So, although the relative proportions of lithiated forms of cathode active material 50 and unlithiated forms of cathode active material 50 may change as the cell 10 cycles, a substantial amount of unlithiated cathode active material 50 is present even when the cell 10 is fully discharged.

In cathodes in which a portion of the cathode active material is not lithiated prior to cycling, the amount of lithium consumed by formation of a solid electrolyte interface (SEI) layer upon cycling may have a greater effect than in cathodes that do not contain unlithiated cathode active material prior to cycling. This effect may be mitigated by adding lithium sources to the cell in other ways, such as by adding lithiated cathode active material or lithium metal to the anode, or by decreasing the N:P ratio, which reflects the capacity ratio between the anode (the negative electrode) and cathode (the positive electrode), in the cell.

One potential source of failure in lithium ion cells and batteries is overcharge. Overcharge occurs when charging current continues to be forced through the cell or battery even after the maximum voltage or state of charge is reached. This can result in the complete delithiation of the cathode, or force the cell to pass current beyond this point. This extreme delithiation and associated high cathode potential can cause any number of problems, including damage to and breakdown of the internal crystal structure of the cathode active material, damage to and breakdown of the structure of cathode layer, including separation of the cathode active material from conductivity enhancers and binders or de-adherence of the cathode layer from the cathode current collector, damage to the electrolyte, and creation of a lithium dendrite that shorts anode-to-cathode, all of which may result in the production of gasses or physical expansion of solid materials that can cause the electrochemical cell or battery to bloat or even explode. These and other types of damage resulting from overcharge can also cause the cell or battery to begin to generate heat at a higher rate than the heat can dissipate to the external environment. When this happens, the situation is referred to as “thermal runaway” because heating is uncontrolled and may even cause further damage that lead to heating an increased rate. The end result of thermal runaway is often explosion or fire.

Even if one instance of overcharge does not result in damage to the cell or battery or thermal runaway, repeated overcharge does progressively more damage to the cell or battery, and makes eventual battery failure well before its intended cycle life or thermal runaway much more likely.

Cathodes 20 of the present disclosure, by virtue of normally containing some unlithiated cathode active material 50 even when cell 10 is fully discharged, limit the amount and extent to which Li can plate at the anode 60 while still operating at a higher potential due to maintaining a built-in cathode state of charge that is greater than 0% even when cell 10 is fully discharged. In some embodiments, the relative amount of unlithiated cathode active material 50 as compared to lithiated cathode active material 50 may optimize the specific energy of cell 10 containing the cathode 20. For example, the relative amount of unlithiated cathode active material 50 may result in a specific energy within 10%, 5%, 2%, 1%, or 0.5% of the maximum actual or theoretical specific energy of cell 10 containing the cathode 20, particularly when combined with an anode 60 as disclosed herein. The relative amount of unlithiated cathode active material 50 may, more specifically, be such that the potential of cathode 20 is enhanced while having minimal effects on cell 10 capacity.

In some embodiments, the bipolar cathode 20 includes an NMC and an NCA. The NMC may be present in a weight % (wt %) as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The NCA may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the bipolar cathode 20 may have two cathode active materials 50a and 50b that consist of NMC and NCA in any of the wt % ranges specified above, such that the total wt % of NMC and NCA is 100 wt %.

In some embodiments, the bipolar cathode 20 includes two NMCs that differ in nickel wt % as compared to the total weight of Ni, Mn, and Co. The first NMC has a higher wt % nickel as compared to the total weight of Ni, Mn, and Co than the second NMC. In some embodiments, the first NMC has a wt % nickel as compared to the total weight of Ni, Mn, and Co of at least 60 wt %, and the second NMC has a wt % nickel as compared to the total weight of Ni, Mn, and Co of at least 50%. In more specific embodiments, the first NMC has a wt % nickel as compared to the total weight of Ni, Mn, and Co of between 60 wt % and about 99 wt %, between 60 wt % and about 95 wt %, between 60 wt % and about 90 wt %, between 60 wt % and about 85 wt %, or between 60 wt % and about 80 wt %, between 60 wt % and about 75 wt %, or between 60 wt % and about 65 wt %, while the second NMC has a wt % nickel as compared to the total weight of Ni, Mn, and Co of between 50 wt % and about 99 wt %, between 50 wt % and about 95 wt %, between 50 wt % and about 90 wt % %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %, provided that the wt % Ni in the second NMC remains below that of the first NMC.

The first NMC may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The second NMC may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %.

In a more specific embodiment, the bipolar cathode 20 may have two cathode active materials 50a and 50b that consist of the first NMC and the second NMC in any of the wt % ranges specified above, such that the total wt % of the first NMC and the second NMC is 100 wt %.

In some embodiments, the bipolar cathode 20 includes an NMC and an NMCA. The NMC may be present in a weight % (wt %) as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The NMCA may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the NMC may be present in in a wt % as compared to total cathode active material weight between about 75 wt % and about 95 wt %, more specifically between about 75 wt % and about 90 wt %, between about 75 wt %, and about 85 wt %, between about 75 wt % and about 80 wt %, between about 80 wt % and about 95 wt %, between about 80 wt % and about 90 wt %, between about 80 wt % and about 85 wt %, between about 85 wt % and about 95 wt %, between about 85 wt % and about 90 wt %, or between about 90 wt % and about 95 wt %. In a more specific embodiment, the bipolar cathode 20 includes two active materials 50a and 50b that consist of NMC and NMCA in any of the wt % ranges specified above, such that the total wt % of NMC and NMCA is 100 wt %.

In some embodiments, the bipolar cathode 20 includes an NCA and a LFP, LMFP, LMNFP, LFCP, or LFMCP. The NCA may be present in a weight % (wt %) as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The LFP, LMFP, LMNFP, LFCP, or LFMCP may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the NCA may be present in in a wt % as compared to total cathode active material weight between about 75 wt % and about 95 wt %, more specifically between about 75 wt % and about 90 wt %, between about 75 wt %, and about 85 wt %, between about 75 wt % and about 80 wt %, between about 80 wt % and about 95 wt %, between about 80 wt % and about 90 wt %, between about 80 wt % and about 85 wt %, between about 85 wt % and about 95 wt %, between about 85 wt % and about 90 wt %, or between about 90 wt % and about 95 wt %. In a more specific embodiment, the bipolar cathode 20 includes two active materials 50a and 50b that consist of NCA and LFP, LMFP, LMNFP, LFCP, or LFMCP in any of the wt % ranges specified above, such that the total wt % of NCA and LFP, LMFP, LMNFP, LFCP, or LFMCP is 100 wt %.

In some embodiments, the bipolar cathode 20 includes an NMC and a LFP, LMFP, LMNFP, LFCP, or LFMCP. The NMC may be present in a weight % (wt %) as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The LFP, LMFP, LMNFP, LFCP, or LFMCP may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the NMC may be present in in a wt % as compared to total cathode active material weight between about 75 wt % and about 95 wt %, more specifically between about 75 wt % and about 90 wt %, between about 75 wt %, and about 85 wt %, between about 75 wt % and about 80 wt %, between about 80 wt % and about 95 wt %, between about 80 wt % and about 90 wt %, between about 80 wt % and about 85 wt %, between about 85 wt % and about 95 wt %, between about 85 wt % and about 90 wt %, or between about 90 wt % and about 95 wt %. In a more specific embodiment, the bipolar cathode 20 includes two active materials 50a and 50b that consist of NMC and LFP, LMFP, LMNFP, LFCP, or LFMCP in any of the wt % ranges specified above, such that the total wt % of NMC and LFP, LMFP, LMNFP, LFCP, or LFMCP is 100 wt %.

In some embodiments, the bipolar cathode 20 includes an NMCA and a LFP, LMFP, LMNFP, LFCP, or LFMCP. The NMCA may be present in a weight % (wt %) as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The LFP, LMFP, LMNFP, LFCP, or LFMCP FP may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the NMCA may be present in in a wt % as compared to total cathode active material weight between about 75 wt % and about 95 wt %, more specifically between about 75 wt % and about 90 wt %, between about 75 wt %, and about 85 wt %, between about 75 wt % and about 80 wt %, between about 80 wt % and about 95 wt %, between about 80 wt % and about 90 wt %, between about 80 wt % and about 85 wt %, between about 85 wt % and about 95 wt %, between about 85 wt % and about 90 wt %, or between about 90 wt % and about 95 wt %. In a more specific embodiment, the bipolar cathode 20 includes two active materials 50a and 50b that consist of NMCA and LFP, LMFP, LMNFP, LFCP, or LFMCP in any of the wt % ranges specified above, such that the total wt % of NMCA and LFP, LMFP, LMNFP, LFCP, or LFMCP is 100 wt %.

In some embodiments, at least one cathode active material 50 can be coated or doped with an inorganic fluoride composition that is not electrochemically active at the operation parameters of the cell. Doped, in this context, means that the inorganic fluoride composition is admixed with the cathode active material, but not chemically bonded to the active material. The inorganic fluoride composition may improve energy density or cycle life of cells containing the bipolar cathode 20 as compared to cells with the same cathode lacking the inorganic fluoride composition. In a specific embodiment, the fluoride composition may increase the number of times the cell may be cycled before experiencing about 25% capacity loss as compared to capacity at the 10^{th} cycle, while changing the energy density of the cell about 10% or less, about 5% or less, about 1% or less, between about 10% and about 0.1%, between about 5% and 0.1%, or between about 1% and 0.1%. Testing may be performed in a test cell as set forth below with respect to energy density testing.

A coating may also decrease the irreversible capacity loss exhibited by the cell 10 upon the first cycle.

Without being limited to a particular theory, the coating may stabilize the crystal lattice of the cathode active material during intercalation and de-intercalation of lithium ions to reduce irreversible changes in the crystal lattice.

Although coating or doping a cathode active material can improve the capacity of a cell containing the cathode active material, the coating itself is not electrochemically active at the operational parameters of the cell. Therefore, when the loss of specific capacity due to the amount of coating or doping material added to a cathode active material exceeds where the benefit of adding coating or doping material, reduction in cell capacity can be expected. In general, the amount of coating or doping material added to the cathode active material can be selected to balance the beneficial stabilization resulting from the coating or doping with the loss of specific capacity due to the weight of the coating or doping material that generally does not contribute directly to a high specific capacity of the material.

In some embodiments, for a cathode active material with a coating or dopant, the amount of coating or dopant or the amount of cathode active material is between about 10 mole % and about 90 mole % of the combined cathode active material and coating or dopant. In more specific embodiments, the amount of coating or dopant or the amount of cathode active material is between about 10 mole % and about 75 mole %, about 10 mole % and about 50 mole %, about 25 mole % and about 90 mole %, about 25 mole % and about 75 mole %, about 25 mole % and about 50 mole %, about 50 mole % and about 90 mole %, about 50 mole % and about 75 mole %, 70 mole % and about 85 mole %, between about 70 mole % and about 80 mole %, between about 70 mole % and about 75 mole %, between about 75 mole % and about 90 mole %, between about 75 mole % and about 85 mole %, between about 75 mole % and about 80 mole %, between about 80 mole % and about 90 mole %, between about 80 mole % and about 85 mole %, or between about 85 mole % and about 90 mole %. Suitable amounts of coating or dopant help reduce or prevent the creation of oxygen gas (O₂) in cell 10 when it operates at higher voltages.

Suitable coating materials include metal fluorides, metalloid fluorides, and any combinations thereof. It has been found that metal/metalloid fluoride coatings can significantly improve the performance of lithium rich layered compositions for lithium ion secondary batteries as demonstrated in the examples in U.S. application Ser. No. 12/246,814 and U.S. application Ser. No. 12/332,735, both incorporated herein by reference in their entireties.

Suitable metals and metalloid elements in the metal fluorides or metalloid fluorides include Al, Bi, Ga, Ge, In, Mg, Pb, Si, Sn, Ti, TI, Zn, Zr and combinations thereof.

Suitable metal fluorides and metalloid fluorides include CsF, KF, LiF, NaF, RbF, TiF, AgF, AgF₂, BaF₂, CaF₂, CuF₂, CdF₂, FeF₂, HgF₂, Hg₂F₂, MnF₂, MgF₂, NiF₂, PbF₂, SnF₂, SrF₂, XeF₂, ZnF₂, AlF₃, BF₃, BiF₃, CeF₃, CrF₃, DyF₃, EuF₃, GaF₃, GdF₃, FeF₃, HoF₃, LnF₃, LaF₃, LuF₃, MnF₃, NdF₃, VOF₃, PrF₃, SbF₃, ScF₃, SmF₃, TbF₃, TiF₃, YF₃, YbF₃, CeF₄, GeF₄, HfF₄, SiF₄, SnF₄, TiF₄, VF₄, ZrF₄, NbF₅, SbF₅, TaF₅, BiF₅, MoF₆, ReF₆, SF₆, WF₆, and any combinations thereof.

In more specific embodiments, the metal fluorides may be LiF, ZnF₂, AlF₃, and any combinations thereof. AlF₃ may be particularly useful due to its reasonable cost and low negative environmental impact.

When used as coatings, metal fluorides and metalloid fluorides may be applied as is known for LiCoO₂ and LiMn₂O₄, for example as described in WO 2006/1109930A, which is incorporated by reference herein, particularly with respect to such coatings and application methods.

The cathode active materials 50a and 50b may be in the form of particles, which may be nanoparticles, microparticles, or agglomerates. Particle size includes any coating on active materials 50a and 50b. Cathode active materials 50a and 50b may have about the same particle size or different particle sizes and similarly may be agglomerated or non-agglomerated, or one particle type may be agglomerated while the other is not.

In some embodiments, the bipolar cathode 20, when used in a test electrochemical cell having i) a cathode including 10 wt % or less of binder mixed with the cathode active material, where wt % is % of total weight of binder and cathode active material; b) a graphite anode, the electrodes with copper and aluminum metal foil current collectors, c) electrolyte, and d) a separator and has a discharge energy density (also referred to as “specific energy”) of 250, 300, or 350 Wh/kg or more when discharged from 4.5V to 2.5V at C/3. In more specific embodiments, the discharge energy density is between about 250 Wh/kg and about 800 Wh/kg, between about 250 Wh/kg and about 700 Wh/kg, between about 250 Wh/kg and about 600 Wh/kg, between about 250 Wh/kg and about 500 Wh/kg, between about 250 Wh/kg and about 400 Wh/kg, between about 250 Wh/kg and about 350 Wh/kg, between about 250 Wh/kg and about 300 Wh/kg, between about 300 Wh/kg and about 800 Wh/kg, between about 300 Wh/kg and about 700 Wh/kg, between about 300 Wh/kg and about 600 Wh/kg, between about 300 Wh/kg and about 500 Wh/kg, between about 300 Wh/kg and about 400 Wh/kg, between about 300 Wh/kg and about 350 Wh/kg, between about 350 Wh/kg and about 800 Wh/kg, between about 350 Wh/kg and about 700 Wh/kg, between about 350 Wh/kg and about 600 Wh/kg, between about 350 Wh/kg and about 500 Wh/kg, or between about 350 Wh/kg and about 400 Wh/kg. In more specific embodiments, the discharge energy density is at least 300, 400, 500, or 600 Wh/kg when discharged from 4.5V to 2.5V, more specifically between about 300, 400, 500, or 600 Wh/kg and about 800 Wh/kg or between about 300, 400, 500, or 600 Wh/kg and about 700 Wh/kg.

In another embodiment, the discharge energy density is 250 Wh/kg, 275 Wh/kg, 300 Wh/kg, 305 Wh/kg, 310 Wh/kg. 315 Wh/kg, 320 Wh/kg, 330 Wh/kg, 335 Wh/kg, 340 Wh/kg, 345 Wh/kg, 350 Wh/kg, 355 Wh/kg, 360 Wh/kg, 375 Wh/kg, 400 Wh/kg, 450 Wh/kg, 500 Wh/kg, or 550 Wh/kg or more when discharged from 4.5V to 2.5V.

In more specific embodiments, the discharge energy density is between 250 Wh/kg, 275 Wh/kg, 300 Wh/kg, 325 Wh/kg, 350 Wh/kg, 355 Wh/kg, 360 Wh/kg, 375 Wh/kg, 400 Wh/kg, 450 Wh/kg, 500 Wh/kg, or 550 Wh/kg and about 800 Wh/kg, between 250 Wh/kg, 275 Wh/kg, 300 Wh/kg, 325 Wh/kg, 350 Wh/kg, 355 Wh/kg, 360 Wh/kg, 375 Wh/kg, 400 Wh/kg, 450 Wh/kg, 500 Wh/kg, or 550 Wh/kg and about 700 Wh/kg, between 250 Wh/kg, 275 Wh/kg, 300 Wh/kg, 325 Wh/kg, 350 Wh/kg, 355 Wh/kg, 360 Wh/kg, 375 Wh/kg, 400 Wh/kg, 450 Wh/kg, 500 Wh/kg, or 550 Wh/kg and about 600 Wh/kg, between 250 Wh/kg, 275 Wh/kg, 300 Wh/kg, 325 Wh/kg, 350 Wh/kg, 355 Wh/kg, 360 Wh/kg, 375 Wh/kg, 400 Wh/kg, or 450 Wh/kg, and about 500 Wh/kg, or between 250 Wh/kg, 275 Wh/kg, 300 Wh/kg, 325 Wh/kg, 350 Wh/kg, 355 Wh/kg, 360 Wh/kg, or 375 Wh/kg, and about 400 Wh/kg. More specifically, the energy density is measured at a cell cycle later than the first cycle, to address first cycle effects. In a more specific embodiment, it is measured at a cycle in the range of cycles where cycle-to-cycle variation in measured energy density is less than 5%. In another more specific embodiment, energy density is measured at a cell cycle that is the tenth cycle or later.

In some embodiments, the bipolar cathode, when used in the test electrochemical cell, has a volumetric discharge energy density of 500 Wh/L or more, 600 Wh/L or more, or 700 Wh/L or more. In more specific embodiments, the volumetric discharge energy density is between 500 Wh/L and about 900 Wh/L, 500 Wh/L and about 800 Wh/L, 500 Wh/L and about 700 Wh/L, 500 Wh/L and about 600 Wh/L, 600 Wh/L and about 900 Wh/L, 600 Wh/L and about 800 Wh/L, or 600 Wh/L and about 700 Wh/L.

In further embodiments, the cell can have a volumetric discharge energy density of at least about 500 Wh/L or at least 600 Wh/L. In some embodiments, the resultant battery can have a volumetric discharge energy density of at least about 500 Wh/L or about 600 Wh/L to 900 Wh/L.

In some embodiments, the bipolar cathode, when used in the test electrochemical cell, has cycle life of about 500 cycles, about 1000 cycles, or about 5000 cycles or more with a capacity decrease of less than about 25% as compared to the capacity at the 10^{th} cycle. In more specific embodiments, the bipolar cathode, when used in a test electrochemical cell, has a cycle life of between about 500 cycles and about 10,000 cycles, between about 1000 cycles and about 10,000 cycles, about 5000 cycles and about 10,000 cycles, about 500 cycles and about 7000 cycles, about 1000 cycles and about 7000 cycles, or about 5000 cycles and about 7000 cycles.

Bipolar cathodes of some embodiments of the present disclosure may exhibit surprisingly high specific capacities in cells, such as the test cell described above, under realistic discharge conditions. In some embodiments, the bipolar cathode may exhibit a specific capacity that is about 100 mAh/g, 150 mAh/g, or 200 mAh/g or more when measured at 23° C. when charged from 4.5 V. In more specific embodiments, the specific capacity may be between about 100 mAh/g and about 400 mAh/g, about 100 mAh/g and about 350 mAh/g, about 100 mAh/g and about 300 mAh/g, about 100 mAh/g and about 250 mAh/g, about 100 mAh/g and about 200 mAh/g, about 150 mAh/g and about 400 mAh/g, about 150 mAh/g and about 350 mAh/g, about 150 mAh/g and about 300 mAh/g, about 150 mAh/g and about 250 mAh/g, about 150 mAh/g and about 200 mAh/g, about 200 mAh/g and about 400 mAh/g, about 200 mAh/g and about 350 mAh/g, about 200 mAh/g and about 300 mAh/g, about 200 mAh/g and about 250 mAh/g, about 250 mAh/g and about 350 mAh/g, about 250 mAh/g and 300 mAh/g, or about 300 mAh/g and about 400 mAh/g.

In more specific embodiments, the bipolar cathode may also have a tap density of about 2 g/cm³ or more, about 2.5 3 g/cm³ or more, or about 3 g/cm³ or more. In more specific embodiments, the tap density may be between about 2 g/cm³ and about 2.5 g/cm³, between about 2 g/cm³ and about 3 g/cm³, between about 2 g/cm³ and about 2.5 g/cm³, between about g/cm³ and about 4 g/cm³, between about 2.5 g/cm³ and about 3 g/cm³, between about 2.5 g/cm³ and about 4 g/cm³, between about 3 g/cm³ and about 4 g/cm³, or between about 3 g/cm³ and about 3.5 g/cm³. In general, when specific capacities are comparable, a higher tap density of a bipolar positive electrode material results in a higher overall capacity of a battery.

During charge/discharge measurements, the specific capacity of a material depends on the rate of charge or discharge. The maximum specific discharge capacity of a cell is typically measured at very slow discharge rates. In actual use, the capacity is less than the measured specific discharge capacity due to discharge at a finite rate. More realistic discharge capacities can be measured using reasonable rates of discharge that are more similar to the rates a cell would experience during use. For low to moderate discharge rate uses, a reasonable testing rate involves a discharge of the cell over three hours. In conventional notation this is written as C/3 or 0.33 C.

In some embodiments, the bipolar cathode used in test cell as described above may have a specific discharge capacity of 100-250, 150-250, 150-200, or 200-250 mAh/g or more at a discharge rate of C/3 at the tenth discharge/charge cycle at 23° C. when charged from 4.5 V In some embodiments, the bipolar cathode used in a test cell as described above may have a specific discharge capacity of about 100-250, 150-250, 150-200, or 200-250 mAh/g or more at a discharge rate of C/10 at the tenth discharge cycle at 23° C. when charged from 4.5 V In either the above embodiment at which the discharge rate is at C/3 or the above embodiment at which the discharge rate is C/10, the bipolar cathode may also have a tap density of about 2 g/cm³ or more, about 2.5 g/cm³ or more, or about 3 g/cm³ or more.

In some embodiments the cathode active materials 50a and 50b have different rate capabilities, which allows for the higher rate cathode active material to contribute fully when the cell is discharged at large current loads without significantly reducing polarization effects associated with high-discharge-rate cathode active materials.

In some embodiments, the cathode active material 50a or the cathode active material 50b may be mixed with an additional material to form layer 30a or layer 30b. In such embodiments, the layer 30a or 30b includes at least about 90 wt % cathode active material 50a or 50b, which, for purposes of this measurement, includes any coating or dopant. More specifically, the layer 30a or 30b may include between about 90 wt % and about 99 wt %, about 90 wt % and about 98 wt %, about 90 wt % and about 97 wt %, about 90 wt % and about 96 wt %, or about 90 wt % and about 95 wt % cathode active material 50 a or 50 b.

In still other embodiments, the cathode layers 30 (30a+30b) may include at least 90 wt % total cathode active material 50 (50a+50b) which, for purposes of this measurement, includes any coating or dopant. More specifically, the cathode layers 30 may include between about 90 wt % and about 99 wt %, about 90 wt % and about 98 wt %, about 90 wt % and about 97 wt %, about 90 wt % and about 96 wt %, or about 90 wt % and about 95 wt % cathode active material 50.

Cathode layers 30a and 30b may include the same or different additional materials, different amounts of the same additional materials, or one layer may include additional materials while the other does not.

Suitable additional materials include polymer binders and conductivity enhancers and combinations thereof.

Suitable conductivity enhancers include carbon fibers, such as vapor grown carbon fibers (VGCF), carbon nanorods, graphite, or carbon blacks, such as acetylene black, Denka black, Keitjen black, hard carbon, silver/gold nano-wires or particles, or any combinations thereof.

In some embodiments, the cathode layers 30 (30a+30b) may include 5 wt % or less conductivity enhancer. More specifically, the cathode layers 30 may include between about 1 wt % and about 5 wt %, between about 2 wt % and about 5 wt %, about 1 wt % and about 4 wt %, about 2 wt % and about 4 wt %, or about 3 wt % and about 4 wt % conductivity enhancer.

Suitable polymer binders include binders that adhere the cathode active material to other components of the cathode 20, such as the other layer 30a or 30b, as the case may be, or the current collector 40. In some embodiments, the polymer binder may include polyvinylidine fluoride (PVDF), polyethylene oxide, polyethylene, polypropylene, polytetrafluoroethylene, polyacrylates, ethylene- (propylene-diene monomer) copolymer (EPDM), water soluble binder, such as synthetic rubber, particularly styrene-butadiene rubber (SBR), styrene-butadiene rubber/carboxyl methyl-cellulose (SBR/CMC), sodium alginate, or sodium acrylate, silicone, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In more specific embodiments, the polymer binder may have a molecular weight of about 200 atomic mass units (AMU) or more. More specifically, the polymer binder may have a molecular weight higher than 200 AMU.

In more specific embodiments, the polymer binder may include PVDF with a molecular weight higher than 200 AMU.

Higher molecular weight polymer binders may facility high loading of cathode active material in a cathode. For example, in some embodiments of the present disclosure, particularly those that use a PVDF with a molecular weight of about 200 AMU or more, or between about 200 AMU and about 5000 AMU in both cathode layer 30a and cathode layer 30b, the combined density of both cathode layers 30 may be about 2 g/mL or more, about 3 g/mL or more or 3.6 g/mL or more. More specifically, it may be between about 2 g/mL and about 5 g/mL, about 2 g/mL and about 4.5 g/mL, about 2 g/mL and about 3.6 g/mL, about 2 g/mL and about 3.5 g/mL, about 3 g/mL and about 5 g/ML, about 3 g/mL and about 4.5 g/mL, about 3 g/mL and about 4 g/mL, about 3 g/mL and about 3.5 g/mL, about 3.6 g/mL and about 5 g/mL, about 3.6 g/mL and about 4.5 g/mL, or about 3.6 g/mL and about 4 g/mL.

In some embodiments, the cathode layers 30 (30a+30b) may include 6 wt % or less polymer binder. More specifically, the cathode layers 30 may include between about 1 wt % and about 6 wt %, between about 2 wt % and about 6 wt %, about 1 wt % and about 5 wt %, about 2 wt % and about 5 wt %, or about 3 wt % and about 5 wt % polymer binder.

Cathode 20 also includes cathode current collector 40, which may be any suitable electrically conductive material, such as a metal foil, a metal grid, a metal screen, metal foam, or expanded metal (which is a metal grid or metal screen that has a thickness sufficient to allow a substantial amount of cathode active material to collect within it) or at least one graphene layer, typically a plurality of graphene layers. In some embodiments, cathode current collector 40 may include Al, Ni, Ti, C, stainless steel, or any combinations thereof. In a specific embodiment, the cathode current collector 40 is aluminum, more specifically aluminum foil. In some embodiments, if the current collector includes or is a metal, it may further include a conductive and corrosion-resistant coating, such as TiN.

Cathode layer 30b is sufficiently adhered to cathode current collector 40 to maintain physical integrity of cathode 20 during the expected life of cell 10, or a battery, such as battery 200, battery 300, or battery 400.

Cathode layer 30a is sufficiently adhered to cathode layer 30b to maintain physical integrity of cathode 20 during the expected life of cell 10, or a battery, such as battery 200, battery 300, or battery 400.

The cathode 20 may have a total cathode active material 50 loading of between about 1 mg/cm² and about 100 mg/cm² total or per side, if both sides have cathode active material.

### Anode

Anode 60, as depicted in FIG. 1, includes anode active material 90 in an anode layer 70. In some embodiments, anode layer 70 may be formed entirely of anode active material 90.

In other embodiments, an additional material, such as a conductivity enhancer or polymer binder may be present. In anodes 60 where lithium ions plate out as lithium metal, anode layer 70 may include anode active material 90 and plated out lithium metal on anode active material 90, in varying amounts of lithium metal depending on the charge/discharge state of electrochemical cell 10.

In some embodiments, the anode active material 90 may include a lithium intercalating carbon, a metal or metal alloy, a silicon-containing material, a metal oxide, or any combinations thereof.

In a more specific embodiment, the anode active material 90 includes a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof.

In specific embodiments, the anode active material 90 includes graphite and silicon.

In more specific embodiments containing a metal alloy, the metal alloy may be combined with an intercalation carbon or a conductive carbon.

In some more specific embodiments, the anode layer 70 may include a cathode active material as an additive.

In some embodiments, the anode active material 90 or anode layer 70 may include a first anode active material and a second anode active material.

In some embodiments, the first anode active material may be a synthetic graphite and may be present in a weight % (wt %) as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The second anode active material may be a natural graphite and may be present in a wt % as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the anode active material 90 or anode layer 70 consists of a synthetic graphite and a natural graphite in any of the wt % ranges specified above, such that the total wt % of synthetic graphite and natural graphite is 100 wt %.

In some embodiments, the first anode active material may be a natural graphite and may be present in a weight % (wt %) as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The second anode active material may be silicon and may be present in a wt % as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the anode active material 90 or anode layer 70 consists of a natural graphite and silicon in any of the wt % ranges specified above, such that the total wt % of natural graphite and silicon is 100 wt %.

In some embodiments, the first anode active material may be a synthetic graphite and may be present in a weight % (wt %) as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The second anode active material may be silicon and may be present in a wt % as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the anode active material 90 or anode layer 70 consists of a synthetic graphite and silicon in any of the wt % ranges specified above, such that the total wt % of synthetic graphite and silicon is 100 wt %.

In some embodiments, the anode active material 90 or anode layer 70 may include a first anode active material, a second anode active material, and a third anode active material.

In some embodiments, the first anode active material may be a synthetic graphite and may be present in a weight % (wt %) as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The second anode active material may be a natural graphite and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The third anode active material may be lithium metal and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. In a more specific embodiment, the anode active material 90 or anode layer 70 consists of a synthetic graphite, a natural graphite, and lithium metal in any of the wt % ranges specified above, such that the total wt % of synthetic graphite, natural graphite, and lithium metal is 100 wt %.

In some embodiments, the first anode active material may be a natural graphite and may be present in a weight % (wt %) as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The second anode active material may be silicon and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The third anode active material may be lithium metal and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. In a more specific embodiment, the anode active material 90 or anode layer 70 consists of a natural graphite, silicon, and lithium metal in any of the wt % ranges specified above, such that the total wt % of, natural graphite, silicon, and lithium metal is 100 wt %.

In some embodiments, the first anode active material may be a synthetic graphite and may be present in a weight % (wt %) as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The second anode active material may be silicon and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The third anode active material may be lithium metal and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. In a more specific embodiment, the anode active material 90 or anode layer 70 consists of a synthetic graphite, silicon, and lithium metal in any of the wt % ranges specified above, such that the total wt % of synthetic graphite, silicon, and lithium metal is 100 wt %.

In some embodiments, anode active material 90, anode layer 70, or anode 60 may lack any lithium metal or lithium ion prior to assembly into cell 10 or prior to the first charge/discharge cycle e.g. when the anode is uncycled. The absence of lithium metal helps preserve excess lithium ion intercalation capacity in the cathode 20 for use if overcharge occurs. In other cases, the anode may include Li+ or Li in the form of a reservoir to supply additional Li+ if the solid electrolyte interface (SEI) consumes too much Li+ during formation.

In some embodiments, the anode may include a conductivity enhancer, polymer binder, other additive, or combinations thereof.

Suitable conductivity enhancers include carbon fibers, such as vapor grown carbon fibers (VGCF), carbon nanorods, graphite, or carbon blacks, such as acetylene black, Denka black, Keitjen black, hard carbon, silver/gold nano-wires or particles, or any combinations thereof.

In some embodiments, the polymer binder may include polyvinylidine fluoride (PVDF), polyethylene oxide, polyethylene, polypropylene, polytetrafluoroethylene, polyacrylates, ethylene- (propylene-diene monomer) copolymer (EPDM), water soluble binder, such as synthetic rubber, particularly styrene-butadiene rubber (SBR), styrene-butadiene rubber/carboxyl methyl-cellulose (SBR/CMC), sodium alginate, or sodium acrylate, silicone, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In more specific embodiments, the polymer binder may have a molecular weight of about 200 atomic mass units (AMU) or more. More specifically, the polymer binder may have a molecular weight higher than 200 AMU.

In some embodiments, the anode layer 70 has a thickness of between about 2 microns and about 8 microns, about 2 microns and about 6 microns, about 2 microns and about 4 microns, about 4 microns and about 8 microns, about 4 microns and about 6 microns, about 6 microns and about 8 microns, about 10 microns and about 100 microns, about 10 microns and about 50 microns, about 10 microns and about 30 microns, about 20 microns and about 100 microns, about 20 microns and about 50 microns, or about 2 microns and about 100 microns.

In some embodiments, not shown, the anode may have an anode layer on both sides of the current collector. In a more specific embodiment, such and anode has a thickness of between about 2 microns and about 1000 microns, about 2 microns and about 8 microns, about 2 microns and about 6 microns, about 2 microns and about 4 microns, about 4 microns and about 8 microns, about 4 microns and about 6 microns, about 6 microns and about 8 microns, about 10 microns and about 100 microns, about 10 microns and about 50 microns, about 10 microns and about 30 microns, about 20 microns and about 100 microns, about 20 microns and about 50 microns, about 2 microns and about 500 microns, or about 2 microns and about 100 microns.

In some embodiments, the anode layer 70 has a total anode active material 90 loading of between about 1 mg/cm² and about 100 mg/cm² total or per side, if both sides have cathode active material.

In some embodiments, the anode layer 70 has a density of between about 0.5 g/mL and about 3 g/mL, about 0.5 g/mL and about 2.5 g/mL, about 0.5 g/mL and about 2 g/mL, about 1 g/mL and about 3 g/mL, about 1 g/mL and about 2.5 g/mL, about 1 g/mL and about 2 g/mL, about 1 g/mL and about 100 g/mL, more specifically between about 1 g/mL and about 75 g/mL, about 1 g/mL and about 50 g/mL, about 1 g/mL and about 25 g/mL, about 25 g/mL and about 100 g/mL, about 25 g/mL and about 75 g/mL, about 25 g/mL and about 50 g/mL, about 50 g/mL and about 100 g/mL, about 50 g/mL and about 75 g/mL, or about 75 g/mL and about 100 g/mL.

Anode 60 may include an anode current collector 80, which may be any suitable electrically conductive material, such as a metal foil, a metal grid, a metal screen, metal foam, or expanded metal (which is a metal grid or metal screen that has a thickness sufficient to allow a substantial amount of anode active material to collect within it) or at least one graphene layer, typically a plurality of graphene layers. In some embodiments, anode current collector 80 may include Cu, Ni, Ti, C, stainless steel, a graphene sheet, or any combinations thereof. In a specific embodiment, the anode current collector 80 is copper, more specifically copper foil. In some embodiments, if the current collector includes or is a metal, it may further include a conductive and corrosion-resistant coating, such as TiN.

In some embodiments, where anode layer 70 is sufficiently conductive, anode 60 may lack a separate anode current collector 80.

In embodiments that include an anode current collector 80, anode layer 70 is sufficiently adhered to anode current collector 80 to maintain physical integrity of anode 60 during the expected life of cell 10, or a battery, such as battery 200, battery 300, or battery 400.

In some embodiments, not depicted, there may be an anode layer on both sides of the anode current collector.

In some embodiments, the anode may include graphite, silicon, or both in the form or particles or separate layers.

In some embodiments, the anode is a high capacity lithium ion anodes that includes a lithium reservoir, such as a graphite-silicon composition anode active material along with a lithium reservoir. The lithium reservoir, in various embodiments, may be lithium metal present in the anode, but not intercalated in the graphite-silicon composition, such as lithium particles or foil, or a lithium salt present in the anode as either free lithium salt or coated on the graphite-silicon composition, or any combinations thereof. It will be understood by one of skill in the art that these initial anode structures exist prior to cell or battery assembly and/or prior to cycling, e.g. in an uncycled cell or battery assembly.

The lithium salt may, in particular embodiments, be lithium bis(trifluoromethanesulfonyl)imide (LIFSI), lithium bis(trifluoromethanesulfonyl)imide (LiTFSI), lithium tetrafluoroborate (LiBF₄), lithium 4,5-dicyano-2-(trifluoromethyl)imidazole (LiTDI), lithium hexafluorophosphate (LiPF₆), lithium iodide (Lil), or any mixtures or combinations thereof, particularly 1-Butyl-3-methylimidazolium bis(trifluoromethanesulfonyl) imide combined with LiTFSI. The lithium salt may further include compounds to enhance electrode stability by impeding the reaction of lithium with oxygen, particularly under normal atmosphere, such as an organic polymer coating.

In some embodiments, the anode may include pre-lithiated silicon.

### Electrolyte

The electrolyte 100 may be a liquid, gel, or solid electrolyte.

The electrolyte 100 may include lithium hexafluorophosphate, or, in another embodiment, the electrolyte 100 may include any chemical composition or mixture of chemical compositions that do not contain lithium hexafluorophosphate as an electrolyte lithium salt. The presence of lithium hexafluorophosphate in the electrolyte composition of lithium batteries has been shown to promote the production of hydrofluoric acid and hydrogen fluoride gas, both of which can lead to increased degradation of the cell or battery. An advantage of the electrolyte compositions disclosed herein is that they avoid or lower the production hydrofluoric acid and hydrogen fluoride gas in the cell or battery, as compared to otherwise similar electrolytes containing lithium hexafluorophosphate. This increases battery safety and may increase cycle life.

Electrolyte 100 may include an ionic liquid, an organic liquid, or a combination thereof. If the ionic liquid or organic liquid does not supply lithium ion, then electrolyte 100 may include a lithium salt. In more specific embodiments, electrolyte 100 may also include a flame retardant.

In some embodiments, the ionic liquid may be any ionic liquid that is a liquid at 20° C. The ionic liquid may be stable (e.g. not degrade to a point where the battery will not function at least 80% of capacity after 10 cycles at 20° C.) up to 70° C. In more specific embodiments, the ionic liquid may include bis(fluorosulfonyl)imide (FSI), bis(trifluoromethane)sulfonamide (TFSI), imidazolium, a phosphonium phosphate, a phosphonium thiophosphate, or any combinations thereof.

If the organic liquid does not supply lithium ion, then electrolyte 100 also includes a lithium salt. In more specific embodiments, electrolyte 100 may also include an additive, such as an additive that reduces or prevents gas creating in cell 10, and additive the reduces or prevents manganese dissolution, or an additive the forms a passivation layer, particularly on the anode, or any combinations of such additives.

In some embodiments, the organic liquid may include:
an ether, such as ethylene glycol dimethyl ether (1,2-dimethoxyethane), ethylene glycol diethyl ether, tetrahydrofuran, 2-methyltetrahydrofuran, 2,6-dimethyltetrahydrofuran, tetrahydropyran, a crown ether, triethylene glycol dimethyl ether, tetraethylene glycol dimethyl ether, 1,4-dioxane, or 1,3-dioxolane;
a carbonic acid ester, such as dimethyl carbonate, methyl ethyl carbonate, diethyl carbonate, diphenyl carbonate, or methyl phenyl carbonate;
a fluorinated ethylene carbonate;
a cyclic carbonate ester, such as ethylene carbonate, propylene carbonate, ethylene 2,3-dimethyl carbonate, butylene carbonate, vinylene carbonate, or ethylene 2-vinyl carbonate;
an aliphatic carboxylic acid ester, such as methyl formate, methyl acetate, methyl propionate, ethyl acetate, propyl acetate, butyl acetate, or amyl acetate;
an aromatic carboxylic acid ester, such as methyl benzoate or ethyl benzoate;
a carboxylic acid ester, such as γ-butyrolactone, γ-valerolactone, or 5-valerolactone;
a phosphoric acid ester, such as trimethyl phosphate, ethyl dimethyl phosphate, diethyl methyl phosphate, or triethyl phosphate;
a nitrile, such as acetonitrile, propionitrile, methoxypropionitrile, glutaronitrile, adiponitrile, 2-methylglutaronitrile, valeronitrile, butyronitrile, or isobutyronitrile;
an amide, such as N-methylformamide, N-ethylformamide, N, N-dimethylformamide, N, N-dimethylacetamide, N-methylpyrrolidinone, N-methylpyrrolidone, or N-vinylpyrrolidone;
a sulfur-based compound, such as dimethyl sultone, methyl ethyl sultone, diethyl sultone, sulfolane, 3-methylsulfolane, or 2,4-dimethylsulfolane;
an alcohol, such as ethylene glycol, propylene glycol, ethylene glycol monomethyl ether, or ethylene glycol monoethyl ether (which may, in some embodiments, be used in a gel polymer electrolyte);
a sulfoxide, such as dimethyl sulfoxide, methyl ethyl sulfoxide, or diethyl sulfoxide;
an aromatic nitrile, such as benzonitrile or tolunitrile;
a nitromethane;
1,3-dimethyl-2-imidazolidinone;
1,3-dimethyl-3,4,5,6-tetrahydro-2(1,H)-pyrimidinone;
3-methyl-2-oxazolidinone; or any combinations thereof.

In some more specific embodiments, the organic liquid includes a carbonic acid ester, an aliphatic carboxylic acid ester, a carboxylic acid ester, an ether, or any combination thereof.

In some embodiments, the flame retardant includes a perfluorocarbon, an alkane, an ether, a ketone, an amine substituted with one or more alkyl groups, or any combinations thereof. In more specific embodiments, the flame retardant may be at least 60% fluorinated (i.e. 60% of the individual flame retardant molecules are fluoridated).

In some embodiments, the flame retardant includes a ketone having the general formula R′(C═O)R″, wherein R′ is a perfluoroalkyl group and R″ is a perfluoroalkyl group or an alkyl group. More specifically, the ketone is a perfluoroketone, such as dodecafluoro-2-methylpentan-3-one.

In other embodiments, the flame retardant includes an ether having the general formula R′OR″, wherein R′ is a perfluoroalkyl group and R″ is a perfluoroalkyl group or an alkyl group. In more specific embodiments, the ether is a segregated hydrofluoroether, such as methoxy-heptafluoropropane, methoxy-nonafluorobutane, ethoxy-nonafluorobutane, perfluorohexylmethylether, or 2-trifluoromethyl-3-ethoxydodecofluorohexane.

In some embodiments, the flame retardant does not contain ethers or, more specifically, fully or partially halogenated ethers.

In some embodiments, the flame retardant includes an amine substituted with one or more perfluoroalkyl groups, such as perfluorotripentylamine, perfluorotributylamine, perfluorotripropylamine, or perfluoro-n-dibutylmethylamine.

In some embodiments, flame retardant can include a perfluoroalkane such as perfluoropentane, perfluorohexane, perfluoroheptane, perfluoroctane, or perfluoro-1,3-dimethylcyclohexane.

In some embodiments, the flame retardant includes a phosphazene, such as a cyclic phosphazene, more particularly cyclotriphosphazene. In more specific embodiments, the cyclic phosphazene is fully or partially halogenated. In even more specific embodiments, the cyclic phosphazene is fully or partially fluorinated. In still other embodiments, additionally or alternately, the cyclic phosphazene has one or more substituents selected from linear or cyclic alkyl groups, alkoxy groups, cycloalkoxy groups, and aryloxy groups. In more specific embodiments, the substituents are unhaloghenated, fully halogenated or partially halogenated. In other more specific embodiments, the cyclic phosphazene is fully substituted with halogens and substituents such as linear or cyclic alkyl groups, alkoxy groups, cycloalkoxy groups, and aryloxy groups.

In some embodiments, electrolyte 100 may include an additive, such as fluoroethylene carbonate (FEC), vinylene carbonate (VC), anhydrides, prop-1-ene-1,3-sultone (PES), or any combinations thereof. In more specific embodiments, the total weight of additives may be about 5 wt % or less of the total electrolyte weight. In still more specific embodiments, the total weight of additive may be between about 1 wt % and about 5 wt %.

In some embodiments, the additive that reduces or prevents gas creation may include vinylene carbonate (VC), poly(ethyl methacrylate) (PEMA), polyethyl phenylethylmalonamide (PEMAO), Li₂Co₃, and any combinations thereof.

In some embodiments, the additive that forms a passivation layer may include VC, as fluoroethylene carbonate (FEC), Poly(3,4-ethylenedioxythiophene) (PEDOT), poly(styrenesulfonate) (PSS), polyvinyl acrylate (PVA), polyethylene glycol (PEG), polyethylene oxide (PEO), poly(methyl methacrylate) (PMMA) and any combinations thereof.

In some embodiments, the additive reduces or prevents Mn dissolution may include VC, FEC, or any combinations thereof.

In some embodiments, the electrolyte 100 may include another additive, such as an anhydride, prop-1-ene-1,3-sultone (PES), or a combination thereof.

In some embodiments, the lithium salt includes LiPF₆, LiFSi, LiTFSI, KFSI, KTFSI, LiBF₄, CH₃COOLi, CH₃SO₃Li, CF₃SO₃Li, CF₃COOLi, Li₂B₁₂F₂, LiBC₄O₈;
salts with the general formula R₁—SO₂—NLi—SO₂—R₂, where R₁ and R₂ independently are F, CF₃, CHF₂, CH₂F, C₂HF, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₂;
salts with the general formula

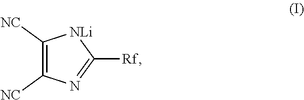

wherein Rf is F, CF₃, CHF₂, CH₂F, C₂HF₄, C₂H₂F, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃; or any combinations thereof.

In some embodiments, the separator 110 includes polyethylene, polypropylene, a ceramic-polymer composite, or any combinations thereof. In more specific embodiments, the separator is a polyethylene-polypropylene-polyethylene tri-layer membrane.

In some embodiments, the separator 110 further includes an electrically insulative material, such as glass. In a specific embodiment, the separator 100 may include glass fibers, particularly glass fibers formed into a porous mat.

In some embodiments, the separator 110 is coated on one or both sides with a ceramic material. In more specific embodiments, the ceramic material includes oxide ceramic, sulfide, Al₂O₃, Al₂O₃—SiO₂, or any combinations thereof.

The voltage of any electrochemical cell according to the present disclosure is the difference between the half-cell potentials at the cathode and the anode, and the cathode active materials and anode active material(s) may be chosen accordingly. The electrolyte may be chosen to avoid or decrease the amount of degradation at the cell voltage.

### Electrode Stacks

The present disclosure relates to electrodes arranged in stacks, such as stacks in which anode/separator/cathode/anode . . . alternate. In some embodiments, the electrode stacks having a slotted structure created by an accordion-shaped separator, which may be referred to as “slot electrodes” or “slot electrode stacks.’ When the separator is folded into an accordion shape, it creates slots on alternating sides of the separator into with cathodes and anodes fit so that there is separator on both sides of each cathode or each anode. A plurality of stopping points, each located at an end of a slot, are also formed by the folds of the separator. These stopping points can help make assembly of the electrode stack easier or prevent electrodes from shifting position too far during use.

In some embodiments, an electrode stack may include alternating layers of cathode/separator/anode. Such a stack might exhibit edge effects, which create areas where electrochemical reactions cannot take place, decreasing the energy density of the cell or battery containing the electrode stack and also possibly resulting in dendrite formation. To avoid this, the ends of the stack may be cut off, for example, with a laser, to achieve more precise boundaries. In some embodiments, scarring resulting from such cutting is performed may be repaired placing metal on the ends of electrode the electrode stack at boundaries after they are cut. In some embodiments, aluminum metal may be placed at one cut edge and copper may be placed at the other cut edge, corresponding to positive and negative ends of the stack.

### Batteries

Batteries of the present disclosure include any bipolar cathode or electrochemical cell disclosed herein. Batteries of the present disclosure may exhibit any of the electrochemical properties attributed to bipolar cathodes, when placed in an electrochemical cell, or electrochemical cells disclosed herein. These properties specifically include discharge energy density, volumetric energy, cycle life, specific discharge capacity, and tap density.

In some embodiments, the battery may be a simple electrochemical cell in a casing. In other embodiments, it may include a more complex electrochemical cell or plurality of cells. For example, in some embodiments, the electrodes may be separated by separators, then rolled within a casing as illustrated in FIG. 5 or stacked within a casing (not shown).

In some embodiments, the casing of a battery may be a polymeric film, a metallic foil, a metal can, or any combination thereof.

In some embodiments, the battery may be thus formed can be a coin or button cell battery, a cylindrical battery, a prismatic cell battery, or pouch cell battery.

In some embodiments, a battery as described herein includes active materials that provide a high degree of safety. Commercial lithium ion batteries have suffered from safety concerns due to occasions of batteries catching fire. In contrast with commercial batteries having relatively high energy capacity, the batteries described herein are based on active materials that do not share the corresponding instabilities of the commercial batteries and thus exhibit thermal run away to a significant lower extent or not at all. In some embodiments, if the batteries described herein are heated, they do not spontaneously react to catch fire. Relatively high energy commercial lithium ion batteries exhibit thermal runaway in which the heated cells undergo reaction and catch fire. Thus, the batteries described herein may provide improved energy capacity as well as providing increased safety during use.

Rechargeable batteries have a range of uses, such as mobile communication devices, such as phones, mobile entertainment devices, portable computers, combinations of these devices that are finding wide use, as well as transportation devices, such as automobiles and forklifts. The batteries described herein that incorporate the bipolar positive electrode active materials can possess improvements with respect to specific capacity and cycling, thereby enhancing their performance in consumer materials, especially for medium current applications. Batteries as described herein may, therefore, be used in a variety of commercial forms.

FIG. 5 illustrates a cylindrical battery 200, according to some embodiments of the present disclosure, that operates using the principles of electrochemical cell 10 depicted in FIG. 1. Battery 200 includes a jelly roll of alternating layers of cathode 20, which has cathode active material 50 on both sides of cathode current collector 40 and anode 60, which also has anode active material 90 on both sides of anode current collector 80. A layer of separator 110 is between each layer of cathode 20 and anode 60. Battery 200 also includes a casing 250 formed from side 210, top 220, and bottom 230. The electrolyte (not shown) is contained by the casing 250.

In some embodiments, the casing 250 has a length L and an average diameter D. In some embodiments, the length L may be between about 2 cm and about 10 cm, about 3 cm and about 10 cm, about 4 cm and about 10 cm, about 4.4 cm and about 10 cm, about 4.45 cm and about 10 cm, about 5 cm and about 10 cm, about 5.05 cm and about 10 cm, about 6.5 cm and about 10 cm, about 2 cm and about 6.5 cm, about 4 cm and about 5.5 cm, or about 4.4 cm and about 5.05 cm, and the diameter D may be between about 1 cm and about 3.5 cm, about 1.05 cm and about 3.5 cm, about 1.45 cm and about 3.5 cm, about 1.5 cm and about 3.5 cm, about 1 cm and about 3 cm, or about 1 cm and about 2 cm, in any combinations of these ranges of lengths and diameters.

In other embodiments, the casing 250 has a length L and an average diameter D. In some embodiments, the length L may be between about 1 cm and about 10 cm, about 5 cm and about 10 cm, about 5 cm and about 8 cm, about 5 cm and about 7 cm, 5 cm and about 20 cm, about 5 cm and about 15 cm, about 5 cm and about 10 cm, 5 cm and about 1 m, about 10 cm and about 1 m, about 20 cm and about 1 m, or about 50 cm and about 1 m, and the diameter D may be between about 1 cm and about 10 cm, about 2 cm and about 6 cm, about 2 cm and about 5 cm, about 2 cm and about 10 cm, or about 5 cm and about 10 cm, in any combinations of these ranges of lengths and diameters.

The cylindrical battery 200 may further include a vent 240. Vent 240 is shown in top 220 in FIG. 5, but it may also be located in bottom 230. Vent 240 is depicted in schematic form only for simplicity and may, in some embodiments, be in a conventional configuration for cylindrical batteries. In addition, cylindrical battery 200 may have more than one vent, which may be located only in top 220, only in bottom 230, or in both top 220 and bottom 230.

In some embodiments, vent 240 may include a valve that allows material to exit battery 200 only when the pressure in battery 200 exceeds a certain value. In more specific embodiments, vent 240 may include a one-way valve or anther similar, one-way release mechanism, such that material may exit battery 200 via vent 240, but not enter battery 200 via vent 240.

In some embodiments, vent 240 may include a screen or mesh that allows gasses to pass, but that substantially blocks the flow of any liquids.

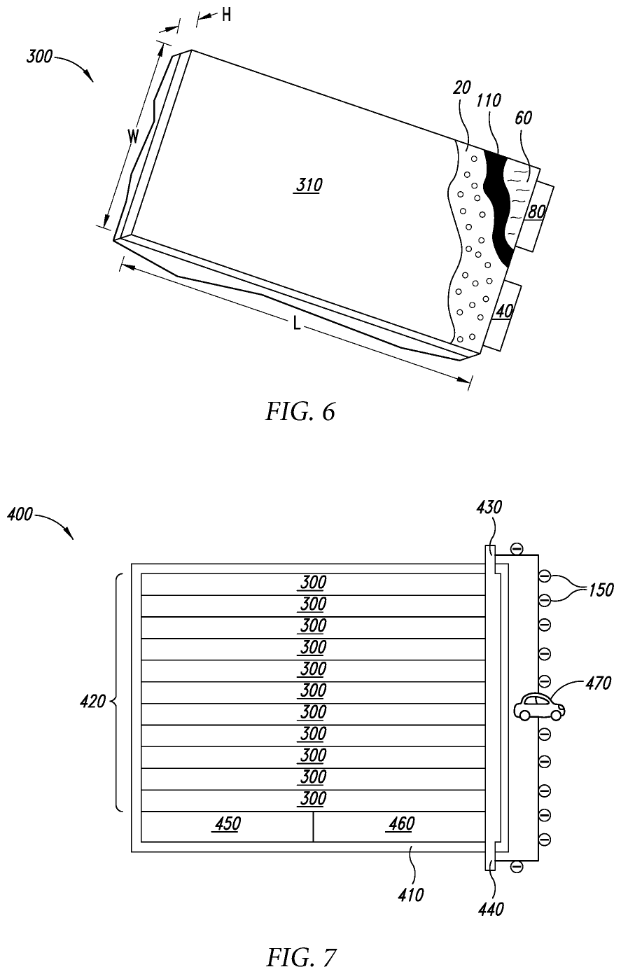

FIG. 6 illustrates a prismatic cell battery 300, according to some embodiments of the present disclosure, that operates using the principles of electrochemical cell 10 depicted in FIG. 1. The battery includes a cathode 20, which includes cathode current collector 40, an anode 60, which includes an anode current collector 80, and a separator 110 between the cathode 20 and the anode 60. Although FIG. 6 illustrates only one cathode 20 and anode 60 for simplicity, the cathodes and anodes are typically stacked in an alternating fashion with separators between them. The cathodes and anodes also typically contain active material on both sides of the respective current collectors.

Prismatic cell battery 300 further includes a casing 310, which is illustrated as a pouch, such as a metal, plastic, or flexible polymer pouch. In some embodiments (not illustrated), casing 310 also includes a vent, which may be located anywhere on casing 310 and which may resemble any of the embodiments of vent 240 as described in the context of FIG. 5.

Prismatic cell battery 300 further includes a casing 310, which is illustrated as a metal pouch. Prismatic cell battery 300 may have a length, L which may be between about 10 cm and about 1 m, between about 10 cm and about 500 cm, between about 10 cm and between about 100 cm, between about 25 cm and about 1 m, between about 25 cm and about 500 cm, between about 25 cm and about 100 cm, between about 50 cm and about 1 m, between about 50 cm and about 500 cm, between about 50 cm and about 100 cm, between about 100 cm and 1 m, or between about 100 cm and about 500 cm, a width, W, which may be between about 2 cm and about 20 cm, about 2 cm and about 10 cm, about 2 cm and about 5 cm, about 5 cm and about 20 cm, or about 5 cm and about 10 cm, and a height, H, between about 2 cm and about 50 cm, about 2 cm and about 20 cm, about 2 cm and about 10 cm, about 5 cm and about 50 cm, about 5 cm and about 20 cm, about 5 cm and about 10 cm, about 10 cm and about 50 cm, or about 10 cm and about 20 cm, in any combinations of these ranges of lengths, width, and heights.

FIG. 7 illustrates an battery module or pack 400, such as a vehicle battery, which includes a stack 420 of prismatic cell batteries 300, such as those illustrated in FIG. 6 or similar to those of FIG. 6, but with stacked cathodes and anodes. Stack 420 is enclosed in a housing 410. Anode current collectors 80 and cathode current collectors 40 in each of batteries 300 are electrically connected to negative connector 430 and positive connector 440, respectively. Electrons 150 may flow between negative connector 430 and positive connector 440 to power vehicle 470, or (not shown), when connected to an energy source, such as a DC power supply, to charge battery 400.

The battery 400 may also include safety equipment 450, control equipment 460, or both. Safety equipment 450 and control equipment 460 may located inside housing 410, or all or part of safety equipment 450 or control equipment 460 may be located outside housing 410. In some embodiments safety equipment 450 may include equipment that minimizes damage should one of batteries 300 fail, or potentially cause damage. For example, safety equipment 450 may include a fan or a fire-suppression material and delivery system. In some embodiments control equipment 460 may include a processor and an associated memory, in which the processor is able to execute a program stored in the associated memory to control one or more functions of the battery 400. The processor may also receive information regarding battery 400, vehicle 470, or batteries 300 and use such information to control one or more functions of battery 400.

Cell or battery 400 may be a large format battery, which may reduce the ratio of the weight of any safety equipment 450, control equipment 460, outside housing 410, and any internal connectors or conductors to the battery weight as compared to the same type of battery in a smaller format. This effectively increases the power density or energy density of the slot electrode battery 400 overall as compared to the same type of battery using smaller internal batteries.

A battery similar to that of FIG. 7 may also be used in a grid storage device, to power a ship, or in other applications where a large format battery are useful.

### Methods of Making Electrodes, Cells, and Batteries

Cathode layers 30a and 30b may be applied to cathode current collector 40 using liquid coating or dry coating with extrusion methods. Although both layers may be applied simultaneously, typically cathode layer 30b is first applied to cathode current collector 40, then cathode layer 30a is applied to cathode layer 30b.

In some embodiments, a paste or slurry containing the cathode active material 50, with any coating or dopant present on or in the active material, and any conductivity enhancers or binders is applied to one or both sides of the cathode current collector 40 then dried. In some more specific embodiments, the electrode is first dried to remove all or part of any solvent used to form the paste or slurry. The electrode may then be pressed using calendaring rolls, a press with a die, or other suitable pressure equipment to compress the electrode to a set thickness. In even more specific embodiments, the electrode is pressed at a pressure between about 70 mPA and about 90 mPA. In other more specific embodiments, the electrode is pressed at a pressure between about 20 kg/cm² and 100 kg/cm².

Anodes may be prepared in a similar fashion.

In some embodiments, particularly where a binder, dopant, or coating is not present, one or both of the cathode active materials 50a and 50b may be deposited in cathode layers 30a and 30b, respectively, on the current collector 40 or the other cathode layer, as the cathode configuration dictates, by chemical vapor deposition. Chemical vapor deposition may be particularly suitable for use with NMC, LFP, LMFP, LMNFP, LFCP, or LFMCP.

### EXAMPLES

The following examples are provide to facilitate an understanding of the embodiments described herein. Elements of the examples may be absent from some embodiments, and elements of the examples may be combined individually with other aspects of embodiments as disclosed herein throughout this specification, not merely within a given example. No example is intended to encompass the entirety of the inventions.

### Example 1: Capacity Fade Under Use Conditions

A specific testing procedure that can be used to evaluate the performance of the cells batteries disclosed herein involves cycling the cell or battery between 4.6 volts (or lower depending on maximum voltage of the cell or battery) and 2.0 volts at 20° C. Evaluation over the range from 4.6 volts to 2.0 volts is particularly relevant to actual use conditions because cells and batteries as described herein typically exhibit stable cycling over this voltage range.

For the first three cycles, the cell or battery is discharged at a rate of C/10 to establish irreversible capacity loss. The cell or battery is then cycled for three cycles at C/5. For cycle 7 and beyond, the cell or battery is cycled at a rate of C/3, which is a reasonable testing rate for medium current applications.

The cell or battery capacity generally depends significantly on the discharge rate, with loss of capacity as the discharge rate increases.

Cells of batteries according to the present disclosure are expected to exhibit a specific discharge capacity during the tenth cycle at a discharge rate of C/3 of 150 mAh/g or more, 200 mAh/g or more, or 210 mAh/g or more.

Furthermore, at the 20^{th} cycle, discharge capacity of the cell or battery is expected to be about 99% or more of that at the tenth cycle at a discharge rate of C/3.

Some cells or batteries may even, at the 20^{th} cycle, have a discharge capacity that is about 99% or more of that 5^{th} cycle discharge capacity at a discharge rate of C/3.

The various embodiments described above can be combined to provide further embodiments. Aspects of the embodiments can be modified in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A bipolar lithium ion cathode comprising two different cathode active materials located in two distinct cathode layers on a single current collector,
wherein:
i) the two different cathode layers are disposed adjacent to one another, and the current collector is disposed adjacent to one cathode layer only:
ii) the current collector is disposed adjacent to and between the two different cathode layers;
iii) the two different cathode layers are both disposed adjacent to the current collector in different regions on a surface of the current collector: or
iv) the cathode comprises two layers each of the distinct cathode layers in which, on one side of the current collector, the two different cathode layers are disposed adjacent to one another and the current collector is disposed adjacent to a first type of cathode layer only and, on an opposite side of the current collector, two different cathode layers are disposed adjacent to cone another and the current collector is disposed adjacent to the first type of cathode layer only; and
wherein the two different cathode active materials are selected from: lithium nickel manganese cobalt oxide (NMC) in which nickel (Ni) is present in at least 50 wt % of the total weight of Ni, manganese (Mn), and cobalt (Co): lithium nickel cobalt aluminum oxide (NCA): lithium nickel manganese cobalt aluminum oxide (NMCA), lithium iron phosphate (LFP), lithium manganese iron phosphate (LMFP), lithium manganese nickel iron phosphate (LMNFP), lithium iron cobalt phosphate (LFCP), lithium iron manganese cobalt phosphate (LFMCP), and any combinations thereof.

2-3. (canceled)

4. The bipolar lithium ion cathode of claim 1, wherein the NMC has the general chemical formula LiNi_{1-x-y}MnₓCo_{y}O₂, wherein 1−x−y, x, and y are each greater than 0, and 1−x−y is such that Ni is present in an amount of at least 50 wt % of the total weight of Ni, Mn, and Co; or wherein x is such that Mn is present in an amount of up to 30 wt % of the total weight of the NMC.

5. The bipolar lithium ion cathode of claim 1, wherein the NCA has the general chemical formula LiNi_{1-x-y}CoₓAl_{y}O₂, wherein 0<x≤0.2 and 0<y≤0.2, or wherein 1−x−y is such that Ni is present in an amount of at least 50 wt % of the total weight of Ni, Co, and aluminum (Al).

6. The bipolar lithium ion cathode of claim 1, wherein the NMCA has the general chemical formula LiNi_{1-x-y-z}MnₓCo_{y}Al_{z}O₂, wherein 0<x≤0.2, 0<y≤0.2, and 0<z≤0.2, or wherein 1−x−y−z is such that Ni is present in an amount of at least 50 wt % of the total weight of Ni, Mn, Co, and Al.

7. The bipolar lithium ion cathode of claim 1, wherein the LFP has the general chemical formula LiFePO₄.

8. The bipolar lithium ion cathode of claim 1, wherein the LMFP has the general chemical formula LiFe₁₋ₓMnₓPO₄, wherein 0<x<1.

9. The bipolar lithium ion cathode of claim 1, wherein the LMNFP has the general chemical formula LiFe_{1-(x+y)}MnₓNi_{y}PO₄, wherein 0<x<1, 0<y<1 and x+y<1.

10. The bipolar lithium ion cathode of claim 1, wherein the LFCP has the general chemical formula LiFe₁₋ₓCoₓPO₄, in which 0<x<1.

11. The bipolar lithium ion cathode of claim 1, wherein the LFCMP has the general chemical formula LiFe_{1-(x+y)}MnₓCo_{y}PO₄, in which 0<x<1, 0<y<1 and x+y<1.

12. The bipolar lithium ion cathode of claim 1, wherein the NMC, NCA, NMCA, LFP, LMFP, LMNFP, LFCP, or LFMCP is partially unlithiated.

13. The bipolar lithium ion cathode of claim 1, wherein the two different cathode active materials comprise two NMCs with different wt % Ni, NMC and NCA, NMC and NMCA, NMC and LFP, or NMC and LMFP.

14. (canceled)

15. A bipolar lithium ion cell comprising:
a bipolar cathode of claim 1;
an anode comprising an anode active material; and
an electrolyte.

16. The bipolar lithium ion cell of claim 15, wherein the anode active material comprises a material selected from: a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, hard carbon, or hard carbon and amorphous silicon or silicon nanotubes, or any combinations thereof.

17. The bipolar lithium ion cell of claim 16, wherein the anode active material comprises graphite and silicon.

18. (canceled)

19. The bipolar lithium ion cell of claim 15, wherein the comprises an ionic liquid, an organic liquid, or a combination thereof and a lithium salt, but electrolyte does not contain lithium hexafluorophosphate as an electrolyte lithium salt.

20. (canceled)

21. The bipolar lithium ion cell of claim 15, wherein the electrolyte further comprises a flame retardant.

22. The bipolar lithium ion cell of claim 15, wherein the cell further comprises a separator between the cathode and the anode, wherein the separator is coated on one or both sides with a ceramic material.

23. The bipolar lithium ion cell of any one of claim 15, wherein the cell:
has a discharge energy density of 200 Wh/kg or more when discharged from 4.5V to 2.5V at C/3;
has a volumetric discharge energy density of 600 Wh/L or more when discharged from 4.5V to 2.5V at C/3;
has a cycle life of about 500 cycles or more; has a specific capacity that is about 100 mAh/g or more when measured at 23° C. when charged from 4.5 V; and/or
has a tap density of about 2 g/cm³ or more or more when measured at 23° C. when charged from 4.5 V.

24-27. (canceled)

28. A battery comprising:
at least one lithium ion cell of claim 15; and
a casing.

29-31. (canceled)

32. A battery module or pack comprising:
at least one battery according to claim 28;
a positive connector;
a negative connector; and
a housing.

33. (canceled)

34. A method of forming a bipolar cathode according to claim 1, the method comprising:
forming a first cathode layer comprising a first cathode active material on a current collector; and
forming a second cathode layer comprising a second cathode active material on the first cathode layer or on the current collector.

35. (canceled)
